(19) United States
(12) Patent Application Publication
(10) Pub. No.: US 2002/0059404 A1
(43) Pub. Date: May 16, 2002

(54) Organizing and combining a hierarchy of configuration parameters to produce an entity profile for an entity associated with a communications network

(76) Inventors: Richard W. Schaaf, Sudbury, MA (US); Daniel G. Petrie, Arlington, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/814,246

(22) Filed: Mar. 20, 2001

Related U.S. Application Data
(60) Provisional application No. 60/190,613, filed on Mar. 20, 2000.

(51) Int. Cl. G06F 15/177

(52) U.S. Cl. 709/220

(57) ABSTRACT

A method of and system for organizing a hierarchy of sets of one or more parameters, for example, configuration parameters, maintaining the plurality of parameter sets, and combining two or more of the plurality of parameter sets to produce a single set of configuration parameters (i.e., an entity profile) for an entity, where such entity may be associated with a communications network. The generated entity profile may be used to configure a device, for example, a network device, associated with the entity. Provided is a digital information product, comprising a computer-readable medium; and first signals tangibly-embodied on the computer-readable medium. The signals define, for an entity associated with a communications network and that belongs to one or more entity groups of a hierarchy of entity groups, a plurality of sets of configuration parameters for configuring a network device of the communications network. Each set corresponds to either the entity or one of the entity groups and, for each set, for one or more configuration parameters, the set defines a value for the configuration parameter. Further provided are a method of and system for assigning values to one or more configuration parameters of a first entity associated with a communications network. The entity is a member of a hierarchy of entity groups, and the communications network comprises a computer-readable medium. A plurality of sets of configuration parameters for configuring a network device of the communications network are retrieved from the computer-readable medium, where each set corresponds to either the entity or one of the entity groups. For each set, for one or more configuration parameters, the set defines a value for the configuration parameter. The plurality of sets of configuration parameters are combined to produce an entity profile for the first entity, where the entity profile comprises one or more configuration parameters and comprises, for each parameter, a corresponding value assigned from one of the plurality of sets of configuration parameters.

### RELATED APPLICATIONS

This application claims priority under 35 U.S.C. § 119(e) to commonly-owned, copending U.S. Provisional Application Serial No. 60/190,613, entitled, “Method and Apparatus for Organizing Configuration Information for a Communications System” filed Mar. 20, 2000, which is hereby incorporated by reference in its entirety.

This application is related to commonly-owned, co-pending U.S. patent application entitled “Distributed Communications Network Including One or More Telephony Communication Devices Having Programmable Functionality”, by James Batson et al. (hereinafter the Batson application), filed Oct. 26, 2000, which is hereby incorporated by reference in its entirety.

### BACKGROUND

There are an ever-increasing number of communications networks at use in the world today. Traditionally, communications networks were divided into several types of communications networks that provided particular types of services, including, among other types, telephony communications networks (e.g., the Public Switched Telephone Communications network (PSTN)) for exchanging audio signals, radio communications networks for exchanging audio signals, television communications networks for exchanging audio and video signals and data communications networks (e.g., a local area networks (LANs) or Metropolitan Area Networks (MANs)) for exchanging data.

Today, because of improved technologies in a variety of fields including, among others, transistor manufacturing, fiber optics, encoding communications, switching communications, routing communications, multiplexing communications, and network traffic engineering, transmission speeds have increased, and, consequently, network bandwidth has expanded, to the point where communications networks (e.g., the Internet) provide a variety of services involving any of a variety of combinations of audio, video, and data services.

More recently, communications networks have begun using data communications networks to transmit voice data and other data between a caller and one or more participants of a telephone call. Typically, these data communications networks are designed to transmit data in accordance with the Internet Protocol (IP). For example, today, some telephony communications networks (e.g., Voice-over-IP (VIP) networks) may provide a variety of telephony, data and even video services. For a typical telephony communications network, including wireless and wire-based communications networks, the endpoints of such a communications network are telephony communication devices (TCDs) such as a telephone or a telephony-enabled computer.

A telephony communication device as used herein is a device capable of performing at least the following traditional telephony tasks: initiating the setting up of a telephone call by sending a signal onto a transmission medium of a communications network, detecting and indicating (e.g., ringing, beeping or blinking a light) that a telephone call is incoming, determining that a user has responded to a phone call (e.g., off-hook detection, a keypad entry, a keyboard entry or a mouse click), sending a signal indicating that the user has responded onto the transmission medium, receiving dialing instructions from a user (e.g., from a rotary dial, push buttons, voice activation, keyboard or mouse), sending a signal representing the dialing instructions on to the transmission medium, transmitting and receiving acoustic audio signals to and from, respectively, a user, and transmitting and receiving media (e.g., audio data) on to the transmission medium of the communications network.

As used herein, “call control” refers to the controlling of setting up, maintaining and tearing down a telephone call. For a typical telephony communication device connected to a LAN, controlling a telephone call typically involves the use of a single call control protocol including peer-to-peer-type protocols such as, for example, the Session Initiation Protocol (SIP) or the H.323 protocol, or a master/slave-type protocol such as, for example, the Media Gateway Control Protocol (MGCP), the Megaco/H.248 protocol, or the Skinny Station protocol promulgated by Cisco Systems, Inc.

The SIP protocol is defined in RFC 2543, SIP: Session Initiation Protocol by Internet Engineering Task Force (IETF) as of March, 1999. The H.323 protocol is described by the International Telecommunications Union in the ITU-TN Recommendation: H.323 Packet-Based Multi-Media Communications System, Geneva, Switzerland, February, 1998. The Megaco/H.248 protocol is defined by IETF RFC 2885 and ITU H.248. The MGCP protocol is described in RFC 2705 as of October 1999.

A communications network may include several network devices (NDs) of varying types, including, among other types, any of a variety of computers, for example, a personal computer, a mainframe computer, a workstation, a minicomputer or server, a communication device, for example, a TCD, a database, a switch, hub, bridge, router, other type of linking device, any of a variety of other types of NDs, and any of a variety of combinations thereof.

NDs may be grouped together, for example, according to common attributes shared by the NDs, such as, among other attributes, type of ND (switch, TCD, personal computer, etc.), manufacturer of ND, location of ND within a network topology, etc. A hierarchy of groups of NDs may be created, and a logical representation of such hierarchy may be maintained (i.e. stored) on one or more NDs of the communications network.

Further, a communications network may have one or more network users (i.e., users) associated with the network. Such users may be associated with a particular ND or may be independent of any particular device on the network. Such users may be grouped together, for example, according to common attributes shared by the users. A hierarchy of groups of users may be created, and a logical representation of such hierarchy may be maintained (i.e. stored) on one or more NDs of the communications network.

A user may be a member of an organization, for example, an employee of an enterprise. Such members may be grouped together, for example, according to common attributes shared by the members, such as, among other attributes, belonging to a same administrative group, for example, a work team or a department of the enterprise. A hierarchy of groups of employees may be created, and a logical representation of such hierarchy may be maintained (i.e. stored) on one or more NDs of the communications network.

As used herein, an “entity” is a device (e.g., an ND), a user, a member (e.g., an employee), or any other elemental unit of an organization of units. An “entity group” is a group of entities, including a device group, which is a group of NDs, a user group, which is a group of users, a member group (e.g., a work team), which is a group of members of an organization (e.g., employees of an enterprise), or any other group of units. An “entity hierarchy” or “hierarchy” is a logical arrangement of entity groups and entities, where the hierarchy includes a plurality of levels, ranked highest to lowest, and where one or more entities correspond to the lowest level of the hierarchy, and each entity group corresponds to a level of the hierarchy higher than the lowest level, and where each entity group and entity, except an entity group corresponding to the highest level of the hierarchy, belongs to an entity group of a higher level.

Types of hierarchies may include a network device hierarchy of NDs and device groups, user group hierarchies of users and user groups, administrative hierarchies of administrative groups and members, and other hierarchies of units and groups of units.

One or more NDs of a communications network may have corresponding configuration parameters for configuring the ND. At any given time, an ND may have a corresponding other entity, for example, a network user using the ND, who may be a member (e.g., employee) of an organization (e.g., enterprise).

Further, as described above, each entity (e.g., ND, user, or member) may be part of an entity group and the entity and entity group may be part of a hierarchy of entity groups and entities. It often is desirable allow values for configuration parameters to be defined for an entity group of a hierarchy so that the entity group may apply some control over the values of configuration parameters for NDs used by entities belonging to the entity group.

For example, it may be desirable for an administrator of a department of an enterprise to define values for configuration parameters to be applied to all NDs used by employees of the department. For example, the department may define a value for a network address of the department supervisor's ND. This value may be a constant value for all employees of the department. Allowing an administrator of a department to define values for configuration parameters may allow the administrator to enforce departmental policy and define privileges for particular employees.

It also may be desirable to allow lower level entity groups or entities to define values for parameters specific to these entities. For example, it may be desirable to allow an employee to define an initial volume setting for an audio device resident on the employee's ND. Allowing an employee to define values for configuration parameters allows for flexibility and customization.

Further, for values of configuration parameters that may be defined by an entity of an entity group, it may be desirable to allow default values to be set for these values by the entity group. For example, it may be desirable to allow an administrator of an enterprise to define one or more default values for a type of ND used by an employee, but to allow one or more of these values to be overridden by the employee if the employee wants to customize the ND.

Also, it may be desirable to allow both an entity group and entities belonging to the group to contribute to the value of a configuration parameter. For example, it may be desirable to allow a system developer or administrator to define a list of applications to be run on an ND, and to allow an ND to add to this list of applications.

For some communications networks, an ND is configured with predefined configuration parameters. Thus, to allow one or more entity groups and/or an entity to define values for the configuration parameters for an ND corresponding to the entity, the values must be predetermined. For example, a consultant of a service provider that provides a service for an enterprise may consult with administrators of each administrative group of an enterprise and/or with individual employees of the enterprise to determine values to be used for configuration parameters of one or more NDs. The consultant then may predefine, for one or more employees, the values for a set of configuration parameters to be applied to one or more NDs used by the one or more employees.

Further, for one or more employees, some configuration parameters may be configured to have values customized by the employee after initial installation. The set of configuration parameters and their defined values then may be persisted and maintained on an ND of the communications network, for example, a ND corresponding to the entity or another ND on the communications network.

A first drawback of this technique for defining values for configuration parameters is that after the ND is installed, many of the values of configuration parameters may be fixed, and little or no reconfiguration of the ND may be accomplished without manually re-defining, on the ND itself, the values of the many configuration parameters. Although this may not be significant for small communications networks, as the number of NDs grows, manual reconfiguration becomes a timely and costly process.

Another drawback of this technique is that although there may be multiple entity groups associated with an entity, each entity group corresponding to a level of a hierarchy, only a single set of configuration parameters and their defined values is persisted and maintained for the entity. Accordingly, the single set of configuration parameters may not maintain (e.g., store a representation of) information about the relationship between the values defined for the one or more configuration parameters of the single set and the hierarchy of entity groups that may have influenced the current values of the configuration parameters.

Thus, information may not be maintained regarding whether a current value of a configuration parameter of the single parameter set resulted from the value being defined as a constant by an entity group, or was a default value defined by an entity group that was overridden by one or more entity groups or entities, or was an aggregation of values defined by an entity and one or more entity groups to which the entity belongs. This information may be lost after the value of the configuration parameter is set manually.

Therefore, each time two or more entity groups (e.g., work group and department) to which an entity (e.g., employee) belongs defines a constant value, default value or contributing value for a same parameter, it must be determined how to assign a value to the configuration parameter for the single parameter set. This determination may include one or more persons (e.g., one or more administrators, an employee, a consultant, a programmer, etc.) determining how best to accommodate the interests of each entity and entity group in defining the value of the configuration parameter. This determination process may have to be repeated each time a value of a configuration parameter is changed.

As an alternative to manually configuring each ND of a communications network, some communications networks have a centralized network resource from which one or more NDs may be configured remotely. For example, a network management station (NMS) or a centralized intelligence for the communications network may maintain a database that includes values of configuration parameters for one or more NDs. In the event that an administrator of an administrative group has the authority to change a value of a configuration parameter for one or more members of the administrative group, and the administrator desires to do so, the value of the configuration parameters may be changed, for example, on the NMS, and any ND affected by the change may be notified of the change. The ND then may change the value of the configuration parameter according to the notification received from the NMS.

Although such a technique for changing the value of one or more configuration parameters for one or more NDs may save time and cost over manual configuration and reconfiguration, such a technique does not remedy the drawbacks described above with maintaining only a single set of configuration parameters associated with an entity and not maintaining information about the relationship between the values defined for the one or more configuration parameters of the single set and the hierarchy of entity groups that may have influenced the current values of the configuration parameters.

### SUMMARY

Provided herein is method of and system for organizing a hierarchy of sets of one or more parameters, for example, configuration parameters, maintaining the plurality of parameter sets, and combining two or more of the plurality of parameter sets to produce a single set of configuration parameters (i.e., an entity profile) for an entity, where such entity may be associated with a communications network. The generated entity profile may be used to configure a device, for example, a network device, associated with the entity.

The hierarchy may be any of a plurality of types of hierarchies, for example, an administrative hierarchy of an organization (e.g., an enterprise) that includes one or more members (e.g., employees) and possibly one or more administrative groups (e.g., departments) of members, a network device hierarchy of network devices and device groups, a user device hierarchy of users and user groups or another type of hierarchy in which entities are grouped together, for example, according to one or more attributes that the entities share in common.

Such a system and method may be used to allow entity groups of a hierarchy to implement policy by defining values of parameters, and associating attributes with the values defining how the defined values may be affected, for example, overridden or added to, or not affected, for example, if the value is defined as constant, by values defined for a same parameter by other entity groups at a lower position in the hierarchy. Thus, the attributes associated with one or more values defined by a first entity group may define a scope of control afforded to entity groups at a lower position of the hierarchy.

Accordingly, for a collection of parameters for which values may be assigned to an entity, one or more configuration sets, and by association, the entity groups corresponding to these configuration sets, may contribute values to a sub-set of the collection of configuration parameters.

In an embodiment, provided is a digital information product that includes a computer-readable medium and first signals tangibly-embodied on the computer-readable medium. The signals define, for an entity associated with a communications network and that belongs to one or more entity groups of a hierarchy of entity groups, a plurality of sets of configuration parameters for configuring a network device of the communications network. Each set corresponds to either the entity or one of the entity groups and, for each set, for one or more configuration parameters, the set defines a value for the configuration parameter.

In another embodiment, values are assigned to one or more configuration parameters of a first entity associated with a communications network, where the entity is a member of a hierarchy of entity groups, and the communications network includes a computer-readable medium. A plurality of sets of configuration parameters for configuring a network device of the communications network are retrieved from the computer-readable medium. Each set corresponds to either the entity or one of the entity groups, and for each set, for one or more configuration parameters, the set defines a value for the configuration parameter. The plurality of sets of configuration parameters are combined to produce an entity profile for the first entity. The entity profile includes one or more configuration parameters and includes, for each parameter, a corresponding value assigned from one of the plurality of sets of configuration parameters.

This embodiment may be implemented as a computer program product that includes a computer-readable medium and computer-readable signals stored on the computer-readable medium, which signals define appropriate instructions. These instructions, as a result of being executed by a computer, instruct the computer to perform the acts described above for this illustrative embodiment.

In yet another embodiment, provided is a system for assigning values to one or more configuration parameters of a first entity associated with a communications network, where the entity is a member of a hierarchy of entity groups, and the communications network includes a computer-readable medium. The system includes a configuration management module including one or more inputs to receive from the computer-readable medium a plurality of sets of configuration parameters for configuring a network device of the communications network. Each set corresponds to either the entity or one of the entity groups, and for each set, for one or more configuration parameters, the set defines a value for the configuration parameter. The configuration management module further includes logic to combine the plurality of sets of configuration parameters to produce an entity profile for the first entity. The entity profile includes one or more configuration parameters and includes, for each parameter, a corresponding value assigned from one of the plurality of sets of configuration parameters. The configuration management module further includes an output to output the entity profile.

In another embodiment, provided is a system for assigning values to one or more configuration parameters of a first entity associated with a communications network, where the entity is a member of a hierarchy of entity groups, and the communications network includes a computer-readable medium. The system includes means for retrieving from the computer-readable medium a plurality of sets of configuration parameters for configuring a network device of the communications network. Each set corresponds to either the entity or one of the entity groups, and for each set, for one or more configuration parameters, the set defines a value for the configuration parameter. The system further includes means for combining the plurality of sets of configuration parameters to produce an entity profile for the first entity The entity profile includes one or more configuration parameters and includes, for each parameter, a corresponding value assigned from one of the plurality of sets of configuration parameters.

The features and advantages of the embodiments described above and other features and advantages of these embodiments will be more readily understood and appreciated from the detailed description below, which should be read together with the accompanying drawing figures.

### BRIEF DESCRIPTION OF THE DRAWINGS

In the drawings,

FIG. 1 is a diagram illustrating an example of a communications network;

FIG. 2 is a diagram illustrating an example of a logical representation of an administrative hierarchy including a plurality of configuration parameter sets corresponding to administrative groups of the administrative hierarchy;

FIG. 3 is a block diagram illustrating an example of a database schema for implementing at least a portion of the logical representation of a hierarchy of configuration parameter sets;

FIG. 4 is a flowchart illustrating an example of a method of generating an entity profile from a plurality of sets of configuration parameters;

FIGS. 5A-5B are a flowchart illustrating an example of a method of combining a plurality of configuration parameters in accordance with a combining procedure to produce an entity profile;

FIG. 6 is a flowchart illustrating an example of a method of persisting an entity profile;

FIG. 7 is a table illustrating an example of a list of sets of configuration parameters and their corresponding attributes;

FIG. 8 is a diagram illustrating an example of an entity profile generated from the table of FIG. 7;

FIG. 9 is a data flow diagram illustrating an example of a system for generating an entity profile from a plurality of sets of configuration parameters.

### DETAILED DESCRIPTION

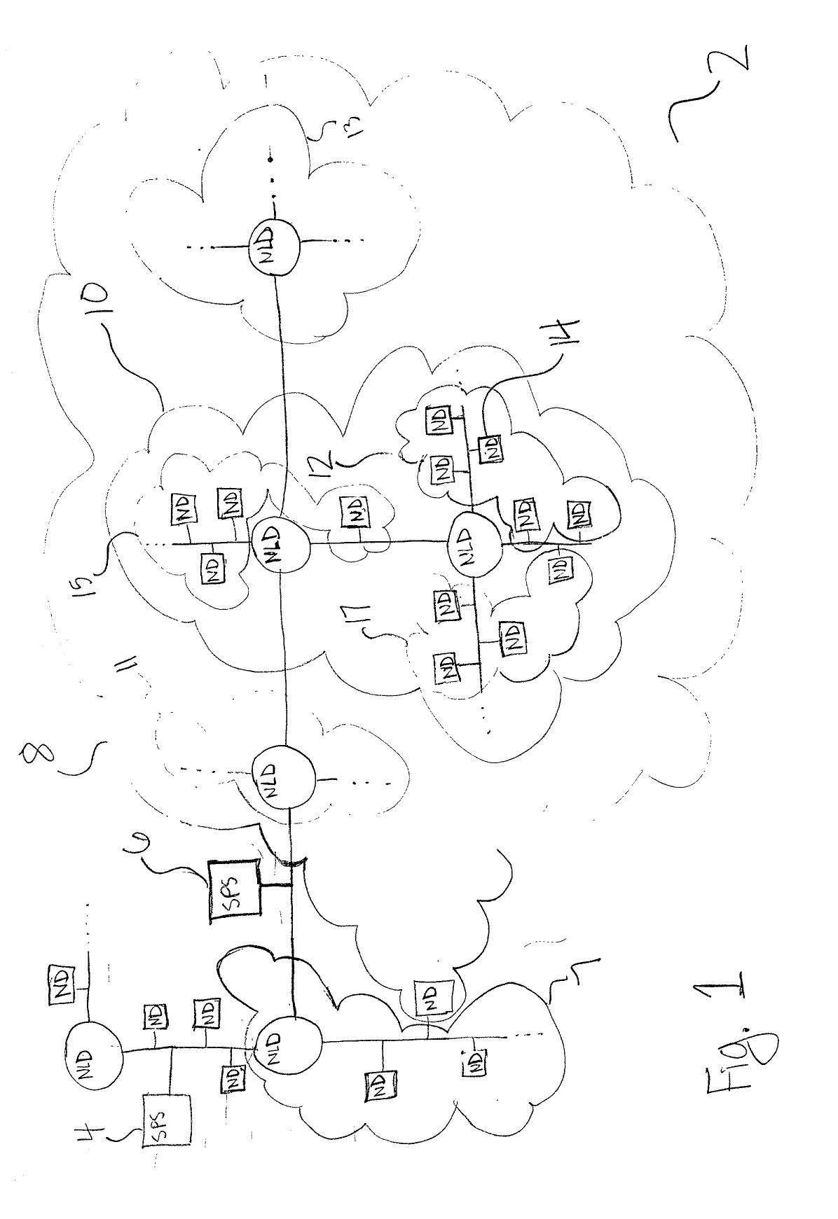

FIG. 1 is a block diagram illustrating an example of a communications network 2. The communications network 2 comprises a plurality of network devices (NDs) represented as squares, a plurality of network linking devices (NLDs) represented as circles, and a plurality of segments of network transmission media (e.g., wire, cable, optical fiber, transmission waves), which are represented as lines.

An ND can be any of a plurality of types of network devices including, among other things, any of a variety of computers, for example, a personal computer, a mainframe computer, a workstation, a minicomputer or server, a communication device, for example, a telephony communications device (TCD), a database, or any of a variety of other types of network devices.

A NLD is a type of ND that is capable of switching, and/or routing packets of data between segments of transmission media. For example, an ND may be a switch, hub, bridge, router, other type of linking device, or a combination thereof.

An SPS is another type of ND. An SPS is a server configured to provide services associated with a service provider. For example, for a telephony communications network (e.g., a Centrex network), an SPS may be an ND that provides any of a variety of services for the telephony communications network such as configuring, operating, maintaining and administering the telephony communications network and one or more NDs on the communications network.

These NDs, NLDs and SPSs together form a physical infrastructure of the communications network 2.

Further, the communications network 2 may include any of a variety of NDs and NLDs described in the Batson application.

For example, an ND may be a TCD that is capable of being programmed, for example, with one or more telephony applications. Such a programmable TCD may have an open telephony system architecture such that one or more telephony applications defined on the telephony communication device may be modified, after initial deployment in the field (e.g., on a customer premise), independently of a vendor that controlled development of the one or more telephony applications. Such a TCD may be a LAN-connected telephone such as the Pingtel xpressa™ by Pingtel Corporation of Woburn, Mass.

Such a programmable TCD may have an extensible telephony system architecture such that the telephony functionality defined thereon can be expanded by adding telephony applications to the TCD. Further, such a programmable TCD may be capable of controlling a connection during a telephone call using any of a plurality of call control protocols, including SIP, H.323, MGCP, Megaco/H.248, and the Skinny Station protocol. Also, for a telephone call involving multiple connections, for example, a conference call, the TCD may control communications on each connection concurrently and can use a different call control protocol for each connection.

The communications network 2 on which the first TCD resides may have any of a variety of configurations. The communications network 2 may be any of a variety of types of communications networks adhering to any of a variety of wireless protocols, e.g., any of a variety of wire-based protocols such as wire-based Ethernet protocols as describe by IEEE 802.3, PCS communications networks, protocols for 3G communications networks or the wireless Ethernet protocol defined by IEEE 802.11, and having any of a variety of network transmission media, such as carrier waves and fiber optic cables.

As described above, an ND may be a TCD, which may be any of a plurality of devices including a telephone or a computer. If an ND is a telephone, it may desirable to provide a companion device to provide additional resources for the telephone, including additional telephony functionality, data storage, and an environment for developing telephony applications.

For example, at a user's home or office, a user may have a TCD embodied as a telephone for participating in telephone calls, and may have a general purpose computer for a variety of other tasks. Although the user's telephone may have more desirable ergonomic features for participating in the telephone call, the general purpose computer may have a plurality of features more desirable for developing applications and storing, retrieving, and manipulating data. For example, a general purpose computer may include peripherals such as a video monitor, a keyboard and a mouse that the telephone embodiment of the TCD lacks. Further, the general purpose computer may have more extensive memory for storing data and applications and for running applications.

To develop applications for a TCD, a companion device may include a plurality of Application Programming Interfaces (APIs), such as one or more of the APIs described in the Batson application. To load these applications onto a TCD, and unload applications from the TCD, a companion device may include an applications manager such as that described above in the Batson application.

A companion device also may be loaded with management software for managing various aspects of the communications network 2 or a sub-network thereof. For communicating and sharing data with other network resources, particularly TCDs, a companion device may be configured to communicate using a number of protocols, including the Simple Network Management Protocol (SNMP), the Hypertext Transport Protocol (HTTP), Remote Method Invocation (RMI), the Hypertext Mark-up Language (HTML), the File Transfer Protocol (FTP), and the Trivial File Transfer Protocol (TFTP).

One or more telephony applications may be stored and executed entirely on a TCD, one or more applications may be distributed such that at least part of the application is stored on another network resource, and one or more applications may be stored remotely from the TCD on another network resource, where the TCD maintains pointers to the remote applications. Accordingly, one or more of the NDs may be application servers that may serve as network resources that store one or more applications and parts of at least one or more applications. For example, an application server may include a voicemail application or the server side of a client/server application, where the client side resides on one or more TCDs.

As the number of TCDs or other types of NDs on the communications network 2 grows, it may be desirable to delegate telephony applications that may be provided by TCDs themselves to other network resources, for example, one or more TCD deployment servers. A TCD deployment server may be configured with a plurality of telephony applications that also may be configured on a TCD. Further, a TCD deployment server may include applications to configure and manage TCDs, perform software upgrades on TCDs, determine which applications should be installed on which TCDs, configure a plurality of TCDs into a hierarchy of groups of TCDs, for example, by geographical region, metropolitan region, business division, business department, building, floor, and group, down to a user. The TCD deployment server also may provide several other services to a TCD or other types of NDs.

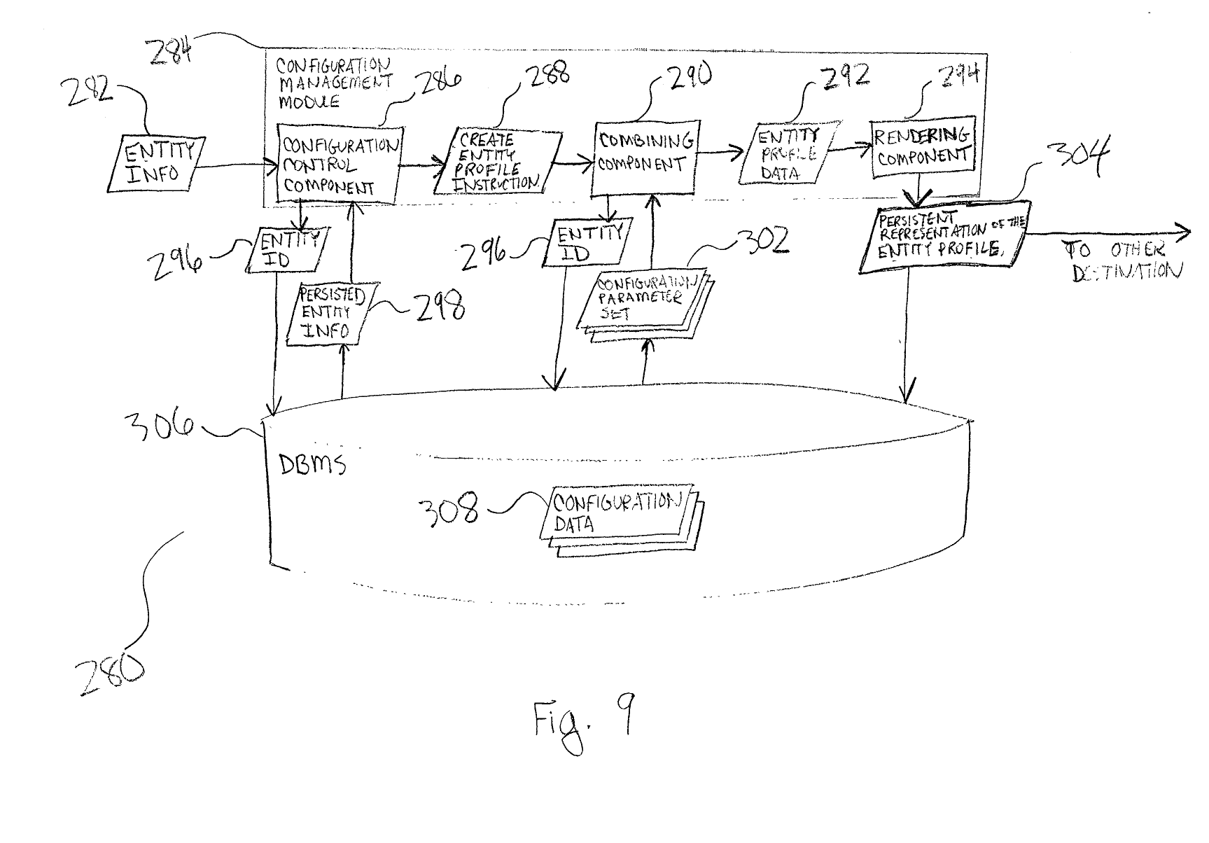

A TCD deployment server may store applications and data in a management database. A management database may be any of a plurality of types of databases including an object-oriented database, a relational database, or a file system. Such a management database may be part of DBMS 306, described below in relation to FIG. 9. Further, to communicate with other NDs, including one or more TCDs and companion devices, a TCD deployment server may be configured to communicate using a number of protocols, including SNMP, HTTP, RMI, HTML, FTP, and TFTP.

In addition to having a physical infrastructure, communications network 2 may be organized into a plurality of sub-networks in any of a variety of ways. For example, communications network 2 may include a plurality of sub-networks as determined by ownership of different portions of the communications network 2. Accordingly, communications network 2 may include sub-network 7 corresponding to (e.g., owned or leased by) a first enterprise (e.g., Blue Chip Corp.) and sub-network 8 corresponding to a second enterprise (e.g., Acme Widgets, Inc.).

One or more sub-networks, for example, sub-networks 7 and 8, may be serviced by a common service provider, for example, Service Provider Corp., which may provide a server, for example SPS 6 to provide services. One or more other service provider servers may provide service to one or more other sub-networks of the communications network 2. For example, another service provider may provide service to one or more other sub-networks using SPS 4.

For each sub-network, for example, sub-network 8 corresponding to the Acme Widgets, Inc. enterprise, for administrative or other reasons, one or more of the NDs or other entities associated with the sub-network (e.g., users), may be grouped together. It may be desirable to group together network devices that share common attributes. For example, one or more NDs, including ND 14, may be grouped into a device group 12. Other NDs may be grouped into a network device group 17, while yet other NDs may be grouped into a device group 15. Network device groups 12, 15 and 17 may be organized according to any of a plurality of shared attributes, for example, each group may correspond to a particular manufacturer. The grouping of NDs may strictly adhere to the topology of sub-network 8, (e.g., if a common attribute shared between the NDs location was within the communications network's topology) although such grouping does not have to strictly adhere to the topology.

Further, other entities such as users may be defined to be associated with only a single ND, for example ND 14, may associated with multiple NDs or may be independent of any particular ND. Further, these other entities may be grouped into groups loosely adhering to or independent of the physical infrastructure of sub-network 8. For example, a user may belong to a user group that loosely adheres to the network infrastructure.

Network devices may be at a lowest level of a network device hierarchy, where groups of these network devices, for example, device groups 12, 15 and 17, may be at an adjacent higher administrative level of the network device hierarchy.

Groups of network devices, for example, device groups 12, 15 and 17, may themselves be grouped into one or more higher-level device groups. For example, device groups 12, 15 and 17 may be grouped into a device group 10 that may be a group of network devices of a common type, for example, TCD, personal computer or NLD. Other device groups, for example, 11 and 13 (network devices not shown), also may be groups of network devices of a common type, for example, device group 11 may represent network devices of a TCD type and device group 13 may represent network devices of a personal computer type.

Further, device groups 10, 11 and 13 may be grouped into one or more higher-level device groups. For example, device groups 10, 11 and 13 may all belong to the Acme Widgets, Inc. device group corresponding to sub-network 8. Further, Acme Widgets, Inc., may be a device group belonging to a group of device groups serviced by a common service provider, for example, a group of network devices serviced by Service Provider Corp. Further, each ND of communications network 2 may correspond to one or more users. For example, ND 14 may be used by an employee of Acme Widget, Inc. who may have a network identity of User 1. Similarly to as described above with respect to network devices, users may be grouped into one or more user groups, and these one or more user groups may be further grouped into one or more other user groups.

Users may be grouped together for a plurality of reasons, for example, for having a plurality of attributes in common. For example, users may be grouped together according to an administrative hierarchy of an organization to which the user belongs. For example, network device 14 may be used by an employee of Acme Widgets, Inc., where the employee belongs to a work team, which belongs to a department of Acme Widgets, Inc. Further, Acme Widgets, Inc. and other enterprises may be grouped together under an administrative group corresponding to a service provider.

FIG. 1 is merely an illustrative embodiment of a communications network 2 including one or more sub-networks. Such an illustrative embodiment is not meant to limit the scope of the one or more claims set forth below and is provided merely for illustrative purposes, as any of a variety of other communications networks and sub-networks may fall within the scope of the one or more claims set forth below.

Although the description below of a method and system for generating an entity profile from a plurality of CPSs corresponding to entity groups of a hierarchy is described primarily in relation to administrative groups of an administrative hierarchy, such method and system may be applied to any of a plurality of types of hierarchies of entity groups, for example, the device groups and network user groups described above.

Regardless of the entity (e.g., network device, network user, or member of an administrative hierarchy such as an employee) and the entity groups corresponding to the entities (e.g., device group, network user group, administrative group), it may be desirable to define some configuration parameters common to all entities of an entity group, and to allow other configuration parameters to be defined individually for each entity.

Configuration parameters may include any of a variety of parameters for configuring a device, for example, a network device such as a programmable TCD such the xpressa™ from Pingtel Corp. For example, one or more configuration parameters may control settings for volume control, display control, security features, application parameters, network addresses of the network device and one or more other network devices, for example, a server, etc. If a network device is a programmable TCD such as the xpressa™ telephone from Pingtel Corp., then one or more configuration parameters may define: control settings for applications which may be downloaded to the programmable TCD; call control protocol parameters, for example, parameters for the SIP protocol; ringer volume, call waiting capabilities, speaker phone volume; an address of a SIP registry server, a SIP proxy server, SIP directory server, an HTTP port for phone set, an address of a deployment server, etc. Other configuration parameters may be specified for an xpressa™ telephone, for example, as described in The Pingtel xpressa™ phone, Volume 1; Installation and Configuration, available from Pingtel Corp. Also, any of a variety of other configuration parameters may be set for a network device.

It may be desirable to combine one or more configuration parameters defined for an entity and one or more configuration parameters defined for a group of such entities into a single set of configuration parameters. Further, it may be desirable to be able to aggregate one or more values defined for a configuration parameter by an entity and/or one or more entity groups, to define a value for the configuration parameter that is constant for all entities of an entity group, and to define a default value for a configuration parameter for an entity group that may be overridden by an entity group or entity lower in the hierarchy.

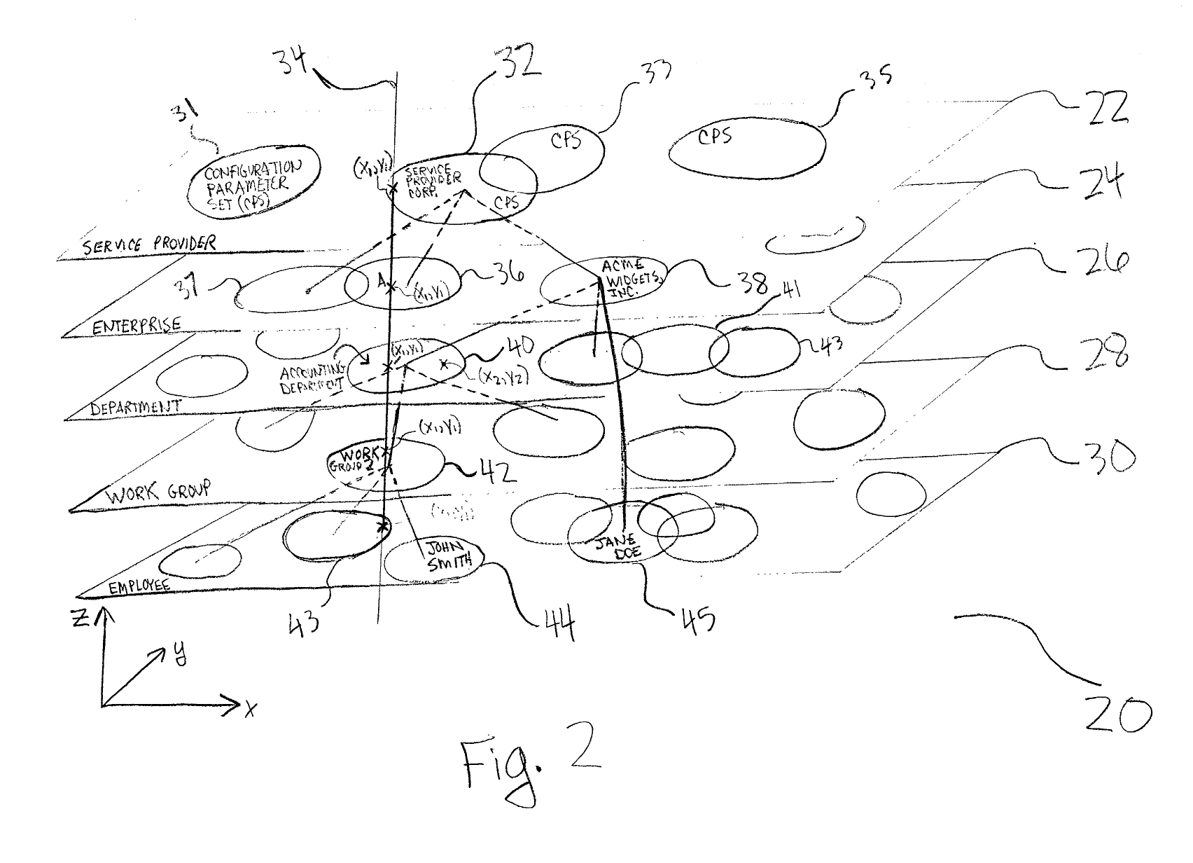

Configuration parameters may be organized, defined, maintained and combined as described below in relation to FIGS. 2-9.

FIG. 2 is a block diagram illustrating an example of a logical representation 20 of an administrative hierarchy. The logical representation 20 includes a plurality of administrative levels: Service Provider level 22, Enterprise level 24, Department level 26, Work Group level 28 and Employee level 30. The higher the location of the level plane along the Z-axis, the higher the corresponding level is in the administrative hierarchy. Each level represents, on the X-Y plane, configuration parameters of the corresponding level for which a value may be defined. Each configuration parameter is represented as a point in the X-Y plane.

Each level may include one or more CPSs, represented as ellipses in FIG. 2, where each CPS defines a set of configuration parameters for an administrative group or entity of the administrative level. For example, service provider level 22 may include CPSs 31, 32, 33 and 35, where each CPS defines a set of configuration parameters for a particular service provider. For example, CPS 33 may correspond to a financial service provider and the parameters for which CPS 33 defines values may be financial parameters corresponding to the financial service provider.

Allowing a plurality of CPSs for each administrative level enables a scope of administrative control to be defined for each administrative group or entity corresponding to the administrative level. For an administrative group or entity, this scope is defined by the configuration parameters included in the CPS corresponding to the group or entity. For example, CPS 40 defines a CPS for the accounting department, whereas CPSs 41 and 43 may define CPSs for a sales department and a customer service department, respectively. An administrator of the accounting department may have the ability to define values for configuration parameters of CPS 40, but may not have the ability to define values for configuration parameters of CPSs 41 and 43.

Although the CPSs define different scopes for different administrative groups or entities of the same level, different administrative groups or entities of the same level may have CPSs that define values for a same parameter. For example, as illustrated by the ellipses of logical representation 20, CPSs 36 and 37 of the Enterprise administrative level both define values for one or more of the same configuration parameters, as do CPSs 41 and 43 of the department administrative level.

For a given parameter, one or more of the levels 22-30 may include one or more CPSs that define a value for the given parameter. For example, line 34 along the Z-axis shows that the parameter defined by (X₁, Y₁) may have a value defined by service provider CPS 32, enterprise CPS 36, department CPS 40, user group CPS 42 and user CPS 43 of levels 22-30, respectively.

The lines drawn between CPSs represent a hierarchical relationship between the CPSs. For a first administrative group of an administrative level, the first administrative group may be associated with one or more administrative groups or entities of an adjacent lower administrative level that belong to the first administrative group. For example, as represented by the straight lines connecting CPS 32 and CPSs 36-38, a service provider entity such as Service Provider Corp. may be associated with one or more enterprise entities such as Acme Widgets, Inc., and the enterprises corresponding to CPSs 36 and 37. For example, employee John Smith corresponding to CPS 44 may belong to Work Group 2 corresponding to CPS 42 as represented by the straight line connecting CPSs 42 and 44.

Although administrative groups and entities are frequently described herein as belonging to an administrative group of an adjacent higher level, and, consequently, most of the CPSs illustrated in logical representation 20 are shown as being hierarchically related to a CPS of an adjacent higher level, this is not always the case. Optionally, an entity or administrative group does not belong to an administrative group of an adjacent higher level, and, consequently, a CPS may not be hierarchically related to a CPS of an adjacent higher level.

For example, Jane Doe may not belong to a Work Group or a department, but may belong to Acme Widgets, Inc. Such an entity may be an executive of Acme Widgets, Inc. or another officer, director or employee of Acme Widgets, Inc. whose position is independent of a department or work group. Accordingly, CPS 45, which corresponds to Jane Doe, may be hierarchically related to CPS 38, but not hierarchically related to any CPSs of the department level 26 or the work group level 328, as illustrated in FIG. 2.

A CPS corresponding to a given administrative group or entity may include values defined for parameters that are also defined by a CPS corresponding to another administrative group, to which the given administrative group or entity belongs, of a higher level. Further, a CPS may define values for parameters for which no other CPS corresponding to another administrative group, to which the given administrative group or entity belongs, of a higher administrative level defines values.

For example, Work Group 2 of the work group level belongs to the Accounting Department of the department level. CPS 42, which corresponds to Work Group 2, defines a value of the parameter corresponding to coordinate (X₁, Y₁). CPS 40, which corresponds to the Accounting Department, also defines a value for the parameter corresponding to coordinate (X₁, Y₁).

In contrast, although the Accounting Department belongs to Acme Widgets, Inc. of the enterprise level, CPS 40 defines a value for the parameter corresponding to coordinate (X₂, Y₂), but CPS 38, which corresponds to Acme Widgets, Inc. does not define a value for the parameter corresponding to coordinates (X₂, Y₂).

As will be described in more detail below, the ability for CPSs of different administrative levels of an administrative hierarchy to each define a value for the same parameter may enable administrative groups and entities at each administrative level to exert at least some degree of control over the value of a configuration parameter. Further, attributes may be associated with the values defined for the configuration parameters such that the values may be combined in a variety of ways to determine a single value for the parameter.

Although FIG. 2 illustrates an example of a logical representation 20 of an administrative hierarchy, the logical representation 20 also may represent other types of hierarchies, for example, a network device hierarchy or a user hierarchy, where levels 22-30 may represent levels of a network device hierarchy or user group hierarchy, respectively, and where the plurality of CPSs correspond to device groups and network devices or user groups and users, respectively.

Logical representation 20 is merely an illustrative embodiment of a logical representation of a hierarchy of administrative levels. Such an illustrative embodiment is not meant to limit the scope of the one or more claims set forth below and is provided merely for illustrative purposes, as any of a variety of other logical representations may fall within the scope of the one or more claims set forth below.

The logical representation 20 may be implemented using any of a variety of data formats and data structures. For example, the logical representation 20 may be implemented in local memory using software such as a procedural programming language, e.g., using one or more records and/or arrays, or an object-oriented programming language, e.g., using one or more classes, objects or other abstractions, and may be implemented using any of a variety of database technologies, for example, a relational database by using one or more database tables, an object-oriented database by using one or more database objects, or another type of database, and may be implemented using a file system including one or more files.

A database, for example. a relational database, typically is stored on a non-volatile recording medium, for example, magnetic tape, or one or more magnetic or optical disks. A local memory is typically an integrated circuit memory element, for example Dynamic Random Access Memory (DRAM) or Static Random Access Memory (SRAM). This local memory typically is more proximately located to and accessed faster by a processing unit (e.g., a microprocessor) of a computer (e.g., a network device) than is a database. During execution of an application defined using one or more programming languages, the application typically is temporarily stored in the local memory and executed by the processing unit, which has relatively fast access to the local memory.

As used herein, an “abstraction” is a logical representation of a thing, where the logical representation is tangibly-embodied on a computer-readable medium, for example, an integrated-circuit memory element, disk, tape or other medium. A “persisted abstraction” is an abstraction tangibly-embodied on a non-volatile recording medium, for example, a tape or disk.

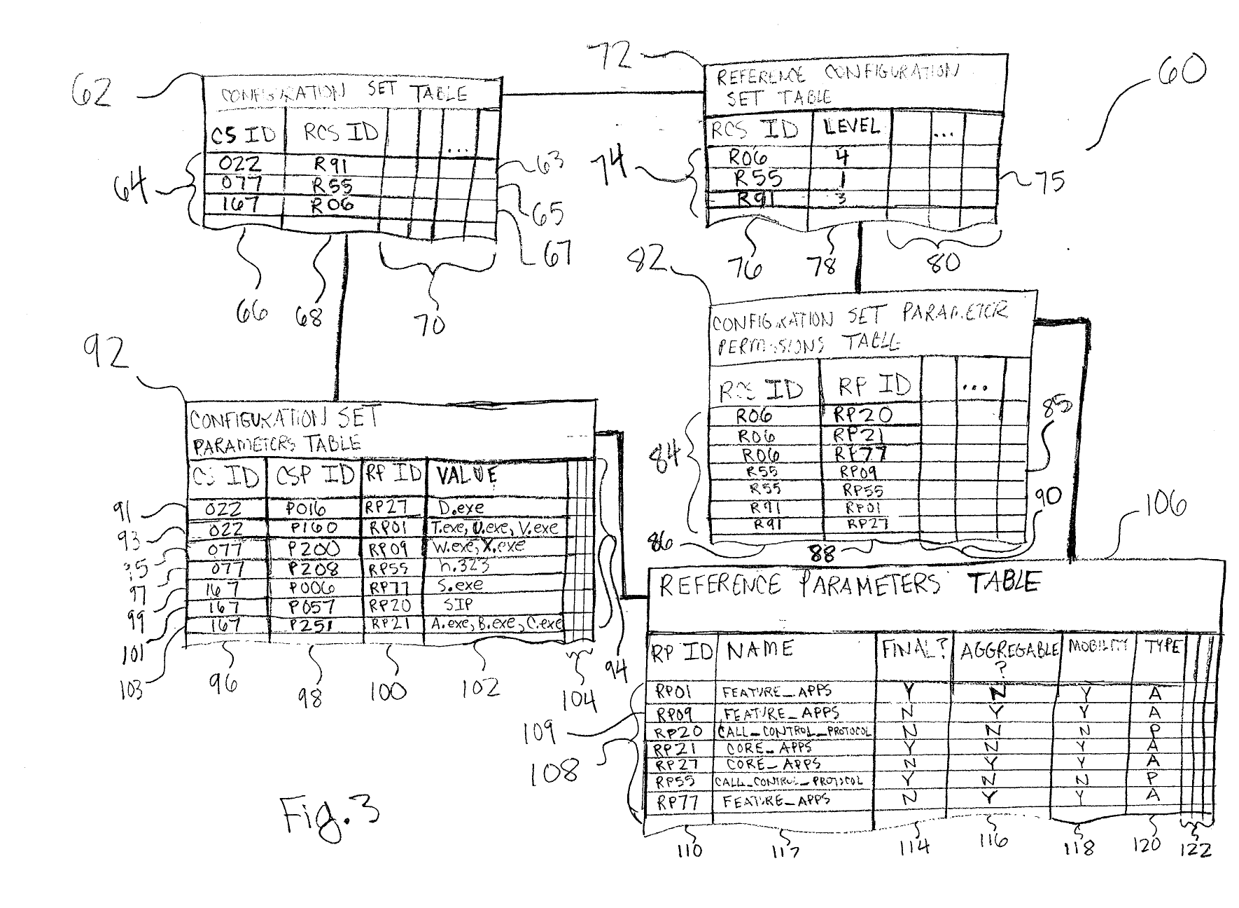

FIG. 3 is a block diagram illustrating an example of a relational database schema 60 for implementing a plurality of CPSs for a hierarchy of entities for example, at least part of the logical representation 20 of FIG. 2. The database schema 60 may include, among other data structures, a configuration set table 62, a reference configuration set table 72, a configuration set parameter permissions table 82, a configuration set parameters table 92 and a reference parameters table 106.

The reference parameters table 106 may be a dictionary of all species of configuration parameters allowed to be defined for a hierarchy. Accordingly, from table 106, one or more configuration parameters may be created and stored in configuration set parameters table 92 described below in more detail. The reference parameters table 106 may include one or more entries 108, where each entry may include a reference parameter (RP) identification (ID) field 110 that may serve as a key for the entry, a name field 112, a final flag field 114, an aggregable field 116, a mobility field 118 and a type field 120. Fields 114, 116, 118 and 120 each pertain to an attribute of the species of parameter identified by field 110. Each entry 108 also may include one or more other fields 122. Each of fields 110, 112, 120 and 122 may be any of a variety of data types, for example, a number or a string. Fields 114, 116 and 118 may be Boolean values.

Each entry 108 of the reference parameters table 106 may correspond to a parameter represented by an X-Y coordinate of one of the administrative levels 22-30 of FIG. 2.

For each entry 108, the RP ID field 110 may store a unique identifier for a species of parameter. The name field 112 may store the name of the parameter identified by field 110.

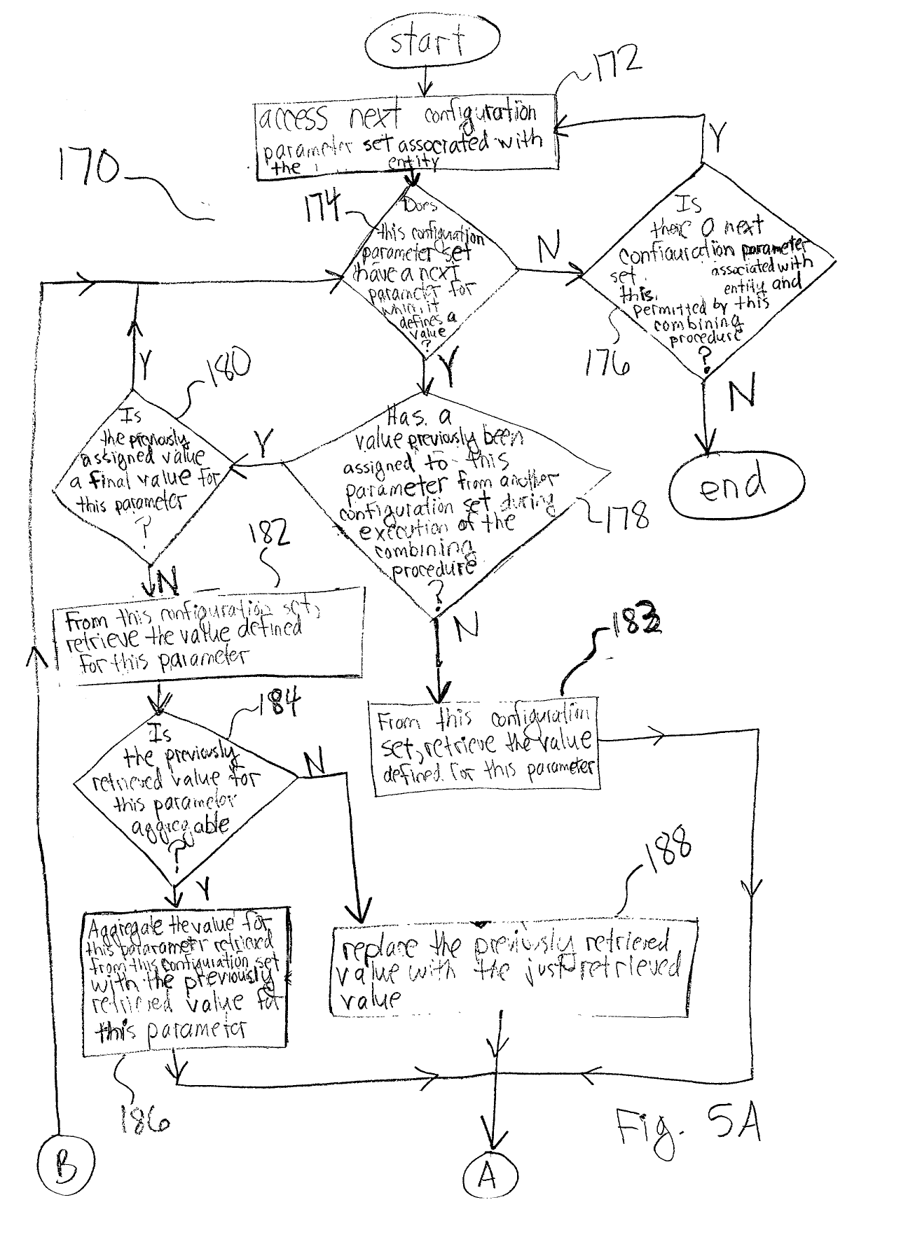

The final flag field 114 may store a Boolean value indicating whether, for the species of parameter identified by field 110, a value defined for a parameter of this species is a final value for a parameter having the name specified by Field 112. Final values for parameters are described below in more detail in relation to FIGS. 5A-5B.

The aggregable flag field 116 indicates whether, for the species of parameter identified by field 110, a value defined for a parameter of this species is aggregable with values defined for parameters having the name specified by Field 112. Aggregable values for parameters are described in more detail below in relation to FIGS. 5A-5B.

The mobility field 118 may store a Boolean value, for example, a flag, indicating whether a parameter of the species of parameter identified by field 110 may be used for more than one network device of a communications network. The mobility value of a parameter is described in more detail below in relation to FIGS. 5A-5B.

The type field 120 may be used to categorize the parameter identified by field 110. For example, if the communications network 2 is a telephony communications network, the type field 120 may indicate that the parameter identified by field 110 is classified as a user-type parameter, a telephone-type parameter or an application-type parameter. Such categorization may be useful for any of a variety of reasons.

Entry 109 is an example of an entry 108 for the reference parameters table 106. Entry 109 specifies a species of parameter having an ID of RP09, which is named FEATURE_APPS, which is non-final, aggregable, mobile and of type “A” (e.g., representing application-type).

The reference configuration set table 72 may be a dictionary of species of CPSs available for a hierarchy. Accordingly, from table 72, one or more CPSs may be created and stored in configuration set table 62 described below in more detail. The reference configuration set table 72 may include a plurality of entries 74, where each entry includes a reference configuration set (RCS) ID field 76 that may serve as a key for the entry and a level field 78. Each entry 74 of the reference configuration set table 72 also may include one or more other fields 80. Fields 76, 78 and 80 may be any of a plurality of data types, for example, a number or a string.

The RCS ID field 76 specifies a unique identifier for the species of CPS and level field 78 specifies a level of the hierarchy of the species of CPS identified by field 76. Level field 78 may be used to define and modify the number of levels of a hierarchy.

For each entry 74, one of the other fields 80 may be a name field corresponding to the level specified by the level field 78. For example, referring to FIG. 2, for a species of CPS of level 22, for an entry 74, the level field 78 may contain an integer 5, and the name field may contain “Service Provider”. Alternatively, a name field may not be included as part of an entry 74, and other system elements or processes may be configured to associate a name of a level with the level specified by level field 78.

Entry 75 is an example of an entry 74 of reference configuration set table 72. Entry 75 specifies a species of CPS of a level 1 and having an ID of R55. entry 74, and other system elements or processes may be configured to associate a name of a level with the level specified by level field 78.

Entry 75 is an example of an entry 74 of reference configuration set table 72. Entry 75 specifies a species of CPS of a level 1 and having an ID of R55.

Configuration set parameter permissions table 82 defines, for one or more species of CPS, the one or more species of parameters permitted for the species of CPS. The configuration set parameter permissions table 82 may include one or more entries 84, where each entry may include an RCS ID field 86 corresponding to an RCS ID field 76 of the reference configuration set table 72 and an RP ID field 88 corresponding to an RP ID field 110 of reference parameters table 106. Each entry 84 of the configuration set permissions table 82 also may include one or more other fields 90. Each field of an entry 84 of table 82 may be any of a variety of data types, for example, a number or a string.

Entry 85 is an example of an entry 84 for the configuration set parameter permissions table 82. Entry 85 specifies that a species of CPS specified by entry 75 of table 72 may include a species of parameter specified by entry 109 of table 106.

Accordingly, when creating a CPS of a particular species, to determine what species of configuration set parameters may be added to the CPS, one or more entries 84 of table 82 may be accessed.

Tables 72, 82 and 106 may be combined in any of a variety of ways to form one or more other tables. For example, tables 72, 82 and 106 may be combined to produce a single reference table having one or more entries, where each entry includes fields identifying a species of CPS, the level for such species, all allowable species of parameters for the species of CPS, names of the allowable species of parameter and, for each permissible species of parameter, attributes associated with the species of parameter, as well as other fields.

Configuration set table 62 lists the CPS currently defined for a hierarchy. The configuration set table 62 may include one or more entries 64, where each entry includes a configuration set (CS) ID field 66 that may serve as a key for the entry and an RCS ID field 68 corresponding to an RCS ID field 76 of reference configuration set table 72. Each entry 64 of the configuration set table 62 also may include one or more other fields 70.

The CS ID field 66 specifies a unique identifier for a CPS, and RCS ID field 68 specifies the species of CPS by serving as a key to an entry 74 of the reference configuration set table 72. Each field of an entry 64 of configuration set table 62 may be any of a plurality of data types, for example, a number or a string.

Entry 65 is an example of an entry 64 of configuration set table 62. Entry 65 specifies that CPS 077 is a species of CPS specified by entry 75 of reference configuration set table 72.

Each entry 64 of table 62 may correspond to a CPS of FIG. 2. Further, one of the other fields 70 may be a name field that specifies, for an entry 64, a name for the CPS specified by field 66. This name may be descriptive of the CPS specified by field 66. For example, entry 67 of table 62 may represent CPS 38 of FIG. 2, which may correspond to the Acme Widgets, Inc., enterprise. Accordingly, name field for entry 67 may specify the name “Acme CPS” or another name descriptive of the CPS.

The configuration set parameters table 92 defines the parameters for each CPS defined by an entry 64 of configuration set table 62. The configuration set parameters table 92 may include one or more entries 94, where each entry 94 may include a CS ID field 96 corresponding to a CS ID field 66 of configuration set table 62 and a configuration set parameter (CSP) ID field 98 that specifies the unique ID for a parameter included in the CPS identified by field 96. The CSP ID field 98 may serve as a key for the entry.

Each entry 94 also may include an RP ID field 100 that specifies the species of the parameter identified by field 98 by serving as a key to an RP ID field 110 of an entry 108 of the reference parameters table 106.

Further, each entry 94 may include a value field 102 that contains a value defined for the parameter identified by field 98, and may include one or more other fields 104. Each field of an entry 94 of configuration set parameters table 92 may be any of a variety of data types, for example, a number or a string.

Entry 95 is an example of an entry 94 for configuration set parameters table 92. Entry 95 specifies that parameter P200 is a species of parameter specified by entry 109 of reference parameters table 106 having a value “W.exe, X.exe”, and that parameter P200 belongs to the CPS specified by entry 65 of configuration set table 62.

Each entry 94 may correspond to a parameter belonging to one of the CPSs illustrated in FIG. 2, in particular, a CPS identified by CS ID field 96.

The configuration set table 62 and the configuration set parameters table 92 may be combined in any of a variety of ways to produce one or more tables. For example, tables 62 and 92 may be combined to form a single table, where each entry may include, among other fields: a CS ID field 66 uniquely identifying a CPS; an RCS ID field 68 identifying the species of the CPS identified by field 66, a CSP ID field 98 identifying a parameter of the CPS identified by field 66; an RP ID field 100 identifying the species of the parameter identified by field 98; and a value field 102 containing a value for the configuration set parameter identified by field 98.

Further, one or more of the tables 72, 82 and 106 may be combined with either or both of tables 62 and/or 92 to produce one or more other tables. For example, for each entry of the configuration set table 62 or a combination of tables 62 and 92, the entry also may include a level field 78 that specifies the level corresponding to the CPS defined by field 66 and may include one or more of the attribute fields 114-120 that specify attributes of the species of parameter specified by RP ID field 100.

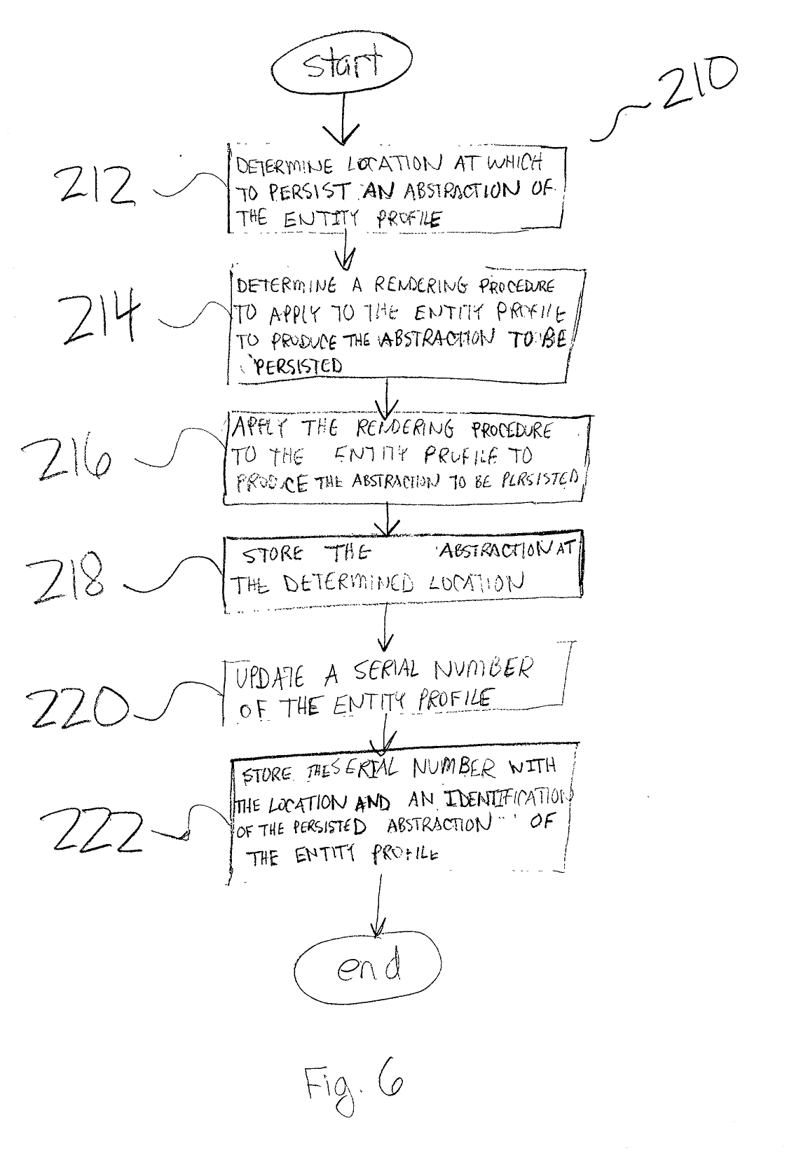

For example, entries from tables 62, 72, 82, 92 and 106 may be combined to form a single database table similar to table 230, described below in more detail in relation to FIG. 7.

Database schema 60 is merely an illustrative embodiment of a database schema for implementing a plurality of CPSs for a hierarchy of entities. Such an illustrative embodiment is not meant to limit the scope of any of the claims set forth below and is provided merely for illustrative purposes, as any of a variety of other database schema for implementing a plurality of CPSs for a hierarchy of entities, for example, variations of database schema 60, may fall within the scope of one or more of the claims set forth below.

Two or more of the CPSs illustrated in FIG. 2 may be combined in any of a variety of ways to produce a single set of configuration parameters that may serve as an entity profile for an entity associated with a network. As used herein, an “entity profile” is a set of parameters, for example, configuration parameters, with which a device, for example, a network device, is configured.

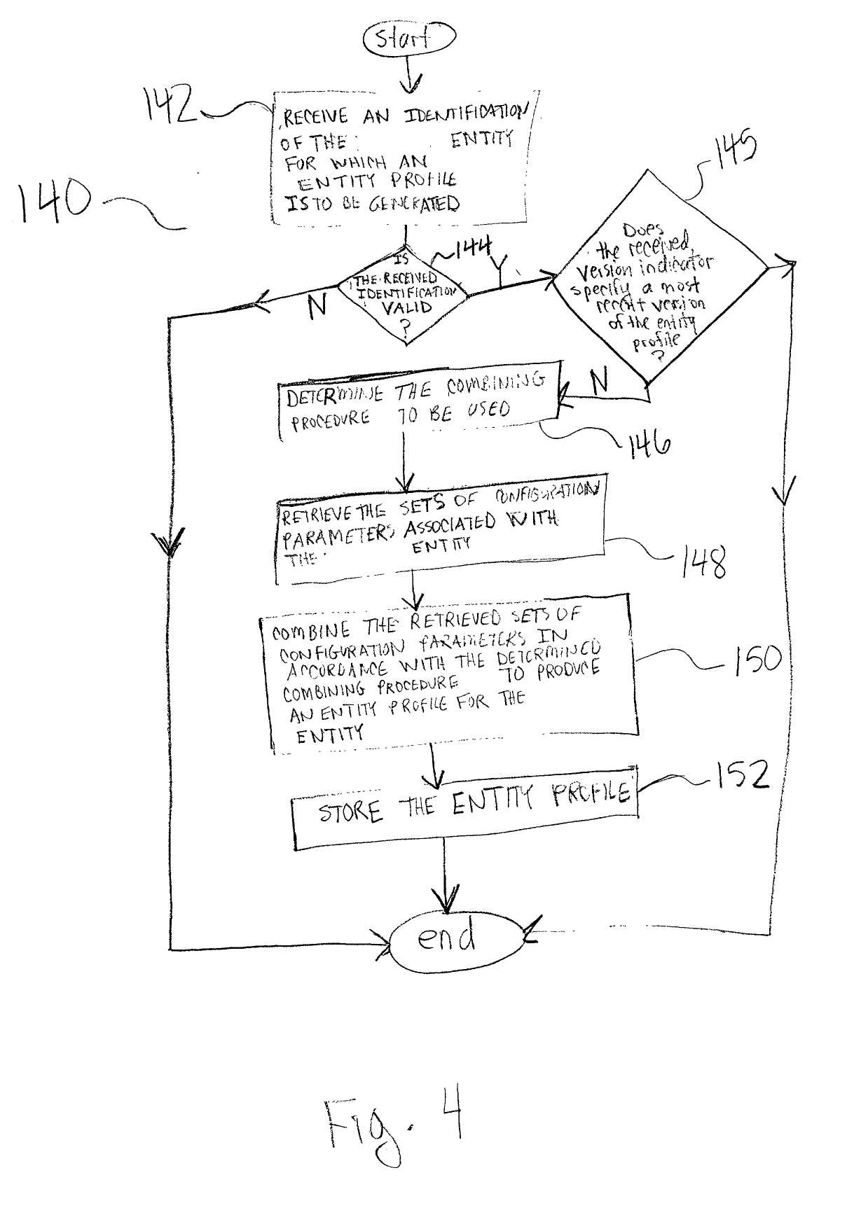

For example, two or more CPSs, each CPS corresponding to a different level of a hierarchy, may be combined to produce an entity profile as described below in more detail in relation to FIGS. 4 and 5A-5B. Such an entity profile may be used to configure a network device of the network.

Although a method of and system for combining a plurality of sets of configuration parameters to produce an entity profile for an entity is described below, such method and system may have several other applications. For example, in addition to configuration parameters, such system and method may be used to combine a plurality of sets of other types of parameters.

Combining a plurality of sets of configuration parameters, where each set corresponds to a level of a hierarchy, into a single set of configuration parameters may be considered as projecting a plurality of dimensions of configuration parameters into a single dimension of entity (e.g., network device, network user, or employee) for which an identify profile is to be generated is received. For example, the entity may be a logical representation of a TCD of a telephony communications network, or a user associated with one or more TCDs of a telephony communications network.

If method 140 is performed by a component of a network device, for example, a part of an application stored in memory or by a hardware component of a network device, then the identification may be received from another component of the network device. Alternatively, the identification may be received from another network device external to the first network device. Such an identification may be received as part of any of a variety of communications, for example, as part of a user log-in or as part of a request to generate the entity profile.

Although entity profiles are frequently described herein as being generated in response to a user login, or a request to generate an entity profile for a particular entity, one or more entity profiles also may be generated in response to a request to generate entity profiles for all entities of a specified entity group such as a network user group, administrative group (e.g., work group or department) or device group. For example, in Act 142, an identification of an administrative group may be received, and then the identity of the administrative group may be verified, for example, as described in Act 144.

Next, a persisted abstraction (e.g., a serialized data object or a database table entry) representing the identified entity group may be accessed. This persisted abstraction may include identifications of entity groups or entities of an adjacent lower level (if any) to the identified entity group. For example, referring to logical representation 20, the identified entity group may be an enterprise corresponding to administrative level 24, in which case the persisted abstraction may include representations of one or more departments of administrative level 26.

Next, persisted entities representing these one or more entity groups or entities of an adjacent lower level may be accessed, and the entity groups or entities of an adjacent lower level (if any) may be identified and accessed. This process may be repeated until the entities of a lowest level have been identified. Alternatively, the persisted abstraction representing the originally identified entity group may include representations of entity groups and/or entities of multiple (e.g., all) levels that belong to the identified entity group. For example, if the identified entity group is an administrative group corresponding to administrative level 22, the persisted entity may include representations of administrative groups and employees of multiple (e.g., all) levels that belong to the identified entity group. For example, if the identified entity group is an administrative group corresponding to administrative level 22, the persisted entity may include representations of administrative groups and employees belonging to the identified administrative group, each employee of administrative group corresponding to one or more of the administrative levels 24-30.

Acts 144-152 then may be performed for each entity group and entity determined to belong to the identified entity group, as described below in more detail.

In a next Act 144, it may be determined whether the received identification is valid. For example, the identification may be compared to a persisted list of identifications for entities associated with the network. These network entities may be persisted in any of a variety of data formats as part of any of a variety of data structures, for example, a text file, a serialized data object, a relational database table entry, a register, etc. This persisted list of identifications of entities may be stored on the same network device on which method 140 is being performed or on another network device.

Other information regarding the entity for which an entity profile is to be generated may be received along with the identification of the entity. For example, a version identifier, for example, a serial number, of an entity profile for the entity may be received along with the identification. This version identifier may indicate the version of the entity profile recognized (e.g., persisted) by another device component or another network device as being the most recent version of the entity profile.

Accordingly, in a following act 145, it may be determined whether the received version indicator specifies a most recent version of the entity profile for the entity. For example, persisted entity information for the entity may be accessed from a database or a text file. This persisted entity information may include a version indicator of the most recent version of the entity profile for the entity. If the persisted version indicator is the same as the received version indicator, then the method may end because the other device component or other network device has the most recent version of the entity profile.

Alternatively, if it is determined that the version indicators are not the same, i.e., the persisted version indicator is greater than the received version indicator, then, in Act 146, it may be determined which combining procedure is to be used to generate the entity profile.

Alternatively, if it is determined in Act 144 that the received identification is valid, then in Act 146 it may be performed without performing Act 145. For example, a version indicator may not be included along with the received identification such that Act 145 cannot.

A variety of combining procedures may be used to generate the entity profile. For example, if method 140 is being performed in response to a user logging onto the communications network, then a first combining procedure may be used. Such a first combining procedure may be a default procedure that is used whenever a user logs onto the communications network. Another procedure may be defined to determine an entity profile of a network device in response to the network device being powered on.

Other combining procedures may be used for different scenarios. For example, in response to a particular network device not performing properly, to determine the problem, a particular combining procedure may be used to combine only certain CPSs associated with the entity. For example, only CPSs corresponding to certain levels of a hierarchy may be combined. By limiting the CPSs that may be combined to generate the entity profile, the CPSs causing the problem may be isolated.

For example, referring to the logical representation 20 described above in relation to FIG. 2, a combination procedure may define that only configuration sets of the service provider, enterprise and department levels may be combined to generate an entity profile for an employee of the employee level. Accordingly, to generate an entity profile for John Smith, only CPSs 32, 38 and 40 may be combined, and CPSs 42 and 44 not combined. Thus, it may be determined whether a problem with network devices used by John Smith is caused by values defined by CPSs 42 or 44.

For example, a CPS corresponding to John Smith may define applications to be loaded and executed on a TCD at which John Smith is working and/or may define application parameters associated with such one or more applications. If TCDs at which John Smith has been working continually have errors, a network administrator may run a particular combining procedure to generate an entity profile for John Smith, where this particular combining procedure does not combine the CPSs corresponding to John Smith. Accordingly, when a network device at which John Smith is working is configured, no applications or application parameters defined by the CPS corresponding to John Smith will be used to configure the network device, and it may be determined whether the problems with the network devices at which John Smith works are caused by applications or application parameters defined by John Smith's CPS.

A network device on which the method 140 is being executed may apply a particular combining procedure in response to receiving an instruction, for example, from a network administrator, or may be configured to perform a particular combining procedure. Further, a A network device on which the method 140 is being executed may apply a particular combining procedure in response to receiving an instruction, for example, from a network administrator, or may be configured to perform a particular combining procedure. Further, a network device on which the method 140 is being executed may be configured (e.g., programmed) to determine and select which combining procedure is to be used according to the entity requesting that the entity profile be generated, the situation in which the entity profile is being generated (e.g., a user logging on or an administrator running a diagnostic test), other criteria, or any combination thereof.

Thus, Act 146 may include selecting, from a plurality of combining procedures, a combining procedure to be applied to the sets of configuration parameters retrieved in Act 148 to generate the entity profile. Such selectable configuration parameters may be available on one or more network devices of the communications network, including the network device on which method 140 is being performed.

Next, in Act 148, the sets of configuration parameters applicable to the entity may be retrieved. Act 148 may include first determining the sets of configuration parameters associated with the entity. Such determination may be made in a variety of ways. For example, a persisted abstraction representing the user, for example, one or more objects of an object-oriented database or one or more tables or table entries of a relational database, may be accessed. Such an abstraction may specify a CPS defined for the entity.

Further, the persisted abstraction also may identify entity groups of other levels to which the entity belongs. For example, as illustrated in FIGS. 1 and 2, the entity may be an employee and may belong to a work group, and the work group may belong to a department, and the department may belong to an enterprise, and the enterprise entity may belong to a service provider. After identifying these other entity groups, persisted abstractions representing these entity groups may be accessed and CPSs defined for these entity groups may be identified.

Alternatively, the persisted abstraction that represents the entity may define not only the entity groups to which the entity belongs, but also may define the CPSs corresponding to these entity groups such that each abstraction representing one of the entity groups does not have to be accessed individually to determine the CPSs corresponding to these entity groups.

In response to these CPSs being identified, the one or more CPSs may be retrieved, for example, from one or more tables of a relational database, such as tables 62 and 92 of database schema 60 described above in relation to FIG. 3.

Optionally, Act 148 may include ordering the one or more retrieved CPSs according to the administrative hierarchy. For example, referring to FIG. 2, if the entity is John Smith, who belongs to Work Group 2, which belongs to the Accounting Department, which belongs to Acme Widgets, Inc., which belongs to the Service Provider Corp., then the retrieved CPSs (CPSs) may be CPSs 44, 42, 40, 38 and 32, respectively. The CPSs may be ordered from a top level of the hierarchy to a bottom level of the hierarchy, i.e., in the following order: 32, 38, 40, 42 and 44.

Any of a variety of other orderings may be performed as part of Act 148.

Ordering of the CPSs may be achieved using any of a variety of techniques, for example, by maintaining a list of pointers, where each position in the list points to an abstraction representing the corresponding CPS, or by maintaining an ordered list of the CPSs themselves, where each position in the order contains a corresponding CPS.

For example, FIG. 7 is a table 230 illustrating an example of a list of CPSs associated with an entity for which an entity profile is being generated. The table 230 may include a plurality of rows (i.e., entries) 231, where each entry represents a configuration parameter.

Each entry 231 of table 230 may correspond to an entry 94 of configuration set parameters table 92 described above in relation to FIG. 3. For example, entries 233, 235, and 237 may correspond to entries 103, 99, and 101, respectively; entries 239 and 241 may correspond to entries 91 and 93, respectively and entries 243 and 245 may correspond to entries 95 and 97, respectively. Further, each entry may include a plurality of fields corresponding to the configuration parameter. For example, each field may correspond to one of the fields of one of the tables 62, 72, 82, 92 and 106 of database schema 60 described above in relation to FIG. 3.

Each entry 231 may include a CS ID field 232, a level field 234, a CSP ID field 236, a name field 238, a value field 240, a final field 242, an aggregable field 244 and one or more other fields 246.

As illustrated by table 230, the list of CPSs does not include any sets corresponding to level 2. The lack of level 2 CPSs may result for a variety of reasons. For example, the entity may not belong to any level 2 entity groups or no CPSs may have been defined for the entity group of level 2 to which the entity belongs.

The CS ID field 232 may specify a unique identifier of the CPS to which the parameter identified by field 236 belongs. The value contained in CPS field 232 may be a number or string or other data type that uniquely identifies a CPS. Level field 234 indicates the level of the hierarchy to which the CPS identified by field 232 belongs. The value contained in level field 234 may be a number or string or other data type capable of identifying a level of the hierarchy.

Parameter field 236 may specify a unique identifier for the parameter of entry 231. Field 236 may be a number, string or other data type that uniquely identifies the parameter.

Name field 238 may contain a value specifying the name of the parameter identified by field 236. Different parameters of different CPSs (i.e., different entries of table 230) may have a same name, the significance of which will become more clear below in the description of method 170 of FIGS. 5A and 5B.

Value field 240 may contain a value for the parameter specified by field 236. Final field 242 may contain a Boolean value specifying whether the value specified by field 240 is a final value for a parameter having a name specified by name field 238, and aggregable field 244 may contain a Boolean value indicating whether the value specified by field 240 is an aggregable value for a parameter having a name specified by field 238. Fields 242 and 244 will be described in more detail below in relation to Act 150 of method 140 and method 170.

Such a list as illustrated by table 230 may be implemented using any of a variety of data formats and data structures, for example, an abstraction such as an array of records, an object or other data structure.

Returning to FIG. 4, in a next Act 150, the retrieved sets of configuration parameters may be combined in accordance with the combining procedure determined in Act 146 to produce an entity profile for the entity. As described above, any of a variety of combining procedures may be used to combine CPSs to produce an entity profile.

FIGS. 5A-5B are a flowchart illustrating an example of a method 170 of combining a plurality of CPSs in accordance with a combining procedure to produce an entity profile.

In Act 172, a next CPS, for example, a first CPS, associated with the entity may be accessed. For example, if the CPSs are ordered according to the hierarchy, a CPS corresponding to the next highest level of the hierarchy may be accessed, e.g., by accessing an entry 64 of configuration set table 62.

Alternatively, as described above in relation to Act 148 of method 140, the retrieved sets of configuration parameters may be ordered in a list, for example, in tabular form as illustrated in FIG. 7. Thus, Act 172 may include accessing an entry of Table 230 corresponding to a next CPS.

In a following Act 174, it may be determined whether the accessed CPS has a next parameter for which it defines a value. For example, for each entry 64 of configuration set table 62, configuration set parameters table 92 may include one or more entries 94 specified by CS ID field 96 and CSP ID field 98. Act 174 may include determining if a next entry 94 exists for the configuration set identified by CS ID fields 66 and 96.

Alternatively, Act 174 may include accessing table 230 to determine if this CPS has a next parameter for which it defines a value. For example, if the current CPS is the set identified by entry 237, then Act 174 may include determining that CPS 167 does not have a next parameter for which it defines a value because entry 237 is the last entry in table 230 for set 167.

If it is determined in Act 174 that the CPS does not have a next parameter for which it defines a value, then in Act 176, it may be determined whether there is a next CPS defined for this entity and permitted by the combining procedure being executed. Act 176 may include accessing a list generated by Act 148 to determine if a next CPS is defined for this entity.

For example, if the current CPS is the set specified by CS ID 077, Act 176 may include determining that there is not a next CPS defined for this entity because set 077 is the last set for which entries are listed in table 230.

Alternatively, if the current CPS is the set specified by CS ID 022, then Act 176 may include determining that there is a next CPS, set 077, defined for this entity.

Also, depending on the combining procedure being applied, even if there is a next CPS defined for this entity, the combining procedure may not allow the next CPS to be considered as part of the combining procedure. For example, as described above, certain combining procedures may be used to test whether CPSs defined for a certain level are a source of a problem associated with an entity. Thus, a combining procedure may define that any CPSs defined for the entity and corresponding to any of one or more levels are not to be combined as part of the combining procedure to generate an entity profile for the entity.

For example, Table 230 indicates that CPS 167 corresponds to level 4, CPS 022 corresponds to administrative level 3 and CPS 077 corresponds to administrative level 1. As described above, levels 4, 3 and 1 may correspond to an enterprise level, a department level and an employee level, respectively. Further, Entry 245 shows that CPS 077 defines the value “H.323” for the parameter named CALL_CONTROL_PROTOCOL. To determine whether this call control protocol is the source of a problem associated with entity 077, the combining procedure may specify that CPSs of level 1 are not to be combined to produce the entity profile for the entity.

If such a combining procedure is applied, the resulting entity profile would specify SIP as the call control protocol as specified by entry 237. Accordingly, by configuring the entity with the SIP protocol, it may be determined whether the H.323 protocol was the source of a problem associated with the entity.

If it is determined in Act 176 that there is not a next CPS associated with this entity and permitted by this combining procedure, then the method 170 may end. Alternatively, if it is determined that there is a next CPS associated with this entity that is permitted by this lo combining procedure, then Act 172 may be performed as described above.

If it is determined in Act 174 that the CPS does have a next parameter for which it defines a value, then, in Act 178, it may be determined whether a value from another CPS has previously been assigned to this parameter during execution of the combining procedure. For example, if the current CPS is set 022 and the current parameter is CORE_APPS (see entry 239), then in Act 178 it may be determined that the value “A.exe, B.exe, C.exe” was already retrieved for this parameter from CPS 167 (see entry 233).

If it is determined that a value has been previously assigned to this parameter during execution of the combining procedure, then, in Act 180, it may be determined whether the previously assigned value is a final value for this parameter. A final value for a parameter is a value assigned to the parameter as part of the current combining procedure which cannot be overridden by any later values retrieved for the parameter during execution of the combining procedure.

If it is determined in Act 180 that the previously assigned value for the parameter is a final value for the parameter, then the value of the parameter is not changed and Act 174 is performed as described above. For example, entry 233 defines the value “A.exe, B.exe, C.exe” for CPS 167 as being a final value for the parameter CORE_APPS. Accordingly, if the current CPS is set 022 and the current parameter is the parameter CORE_APPS (see entry 239), Act 180 would determine that the previously retrieved value, “A.exe, B.exe, C.exe” for parameter “CORE_APPS” is a final value, and then Act 174 would be performed without changing the value of CORE_APPS.

Alternatively, if it is determined in Act 180 that the previously assigned value is not a final value for this parameter, then, in Act 182, the value defined for this parameter is retrieved from this configuration set.

For example, if the current CPS is set 077 and the current parameter is the parameter CALL_CONTROL_PROTOCOL (see entry 245), then this parameter has a previously assigned value of “SIP” (see entry 237) which is defined as non-final. Accordingly, this nonfinal status is determined in Act 180, and in Act 182, the value H.323 defined by CPS 077 is retrieved.

In a following Act 184, it may be determined whether the previously assigned value for this parameter is aggregable. A value for a parameter is aggregable if even after a value has been assigned to the parameter as part of the current combining procedure, a value defined by another CPS for the parameter may be aggregated (i.e., added) to the value already assigned to the parameter.

If it is determined in Act 184 that the previously retrieved value for this parameter is aggregable, then, in Act 186, the value for this parameter retrieved from this CPS may be aggregated with the previously assigned value for this parameter.

For example, if the current CPS is set 022 and the current parameter is the parameter named FEATURE_APPS (see entry 241), then the value “T.exe, U.exe, V.exe” would be aggregated (i.e., added) to the value “S.exe” defined by CPS 167 and previously assigned to this parameter. This aggregation would be performed because CPS 167 defines the parameter FEATURE_APPS as an aggregable value.

If in Act 184, it is determined that the previously retrieved value for this parameter is not aggregable, then in Act 188, the previously retrieved value is replaced or overridden with the just-retrieved value. Thus, the value defined for this parameter by the current CPS overrides the value previously assigned this parameter from another CPS.

For example, if the current CPS is set 077, and the current parameter is the parameter CALL_CONTROL_PROTOCOL (entry 245), then this parameter would be set equal to “H.323” because the value “SIP” previously assigned to this parameter is defined by CPS 167 as non-final and non-aggregable. Thus, the value “H.323” defined by set 077 of level 1 (e.g., network user level) overrides the value “SIP” defined by set 167 of level 4 (e.g., enterprise level).

Returning to Act 178, if it is determined in Act 178 that a value has not been previously retrieved for this parameter, then in Act 183, the value defined for this parameter may be retrieved from this CPS.

For example, if the current CPS is set 167 and the current parameter is the parameter FEATURE_APPS (entry 235), then the value “S.exe” may be retrieved and assigned as the value for this parameter.

After Act 183, 186 or 188 is performed, then, in Act 190, it may be determined whether this CPS defines the value for this parameter as being a final value for this parameter, for example, by accessing field 242 of an entry 231 of table 230.

If, in Act 190, it is determined that the current CPS does define the value for this parameter as being final, then, in Act 196, the value assigned to this parameter may be marked as being the final value for this parameter, for example, by setting a flag. For example, if the current CPS is parameter set 077 and the current parameter is the parameter CALL_CONTROL_PROTOCOL (entry 245), then because the CPS 077 defines this value as being a final value in field 242, the assigned value for this parameter may be marked as being final. After Act 196, Act 174 may be performed as described above.

If in Act 190, it is determined that the current CPS does not define the value for this parameter as being a final value for the parameter, then in Act 192, it may be determined whether the current CPS defines the value for this parameter as an aggregable value for this parameter, for example, by accessing field 244 of an entry 231 of table 230.

If it is determined in Act 192 that the current CPS does not define the value for this parameter as being aggregable, then the value is not marked as such and Act 174 is performed as described above. For example, if the current CPS is set 167 and the current parameter is the parameter CALL_CONTROL_PROTOCOL (entry 237), then because aggregable field 244 defines the parameter to be non-aggregable, the value “SIP” is not marked as being aggregable and then Act 174 is performed as described above.

If it is determined in Act 192 that the current CPS does define the value for the current parameter as being an aggregable, then, in Act 194, the retrieved value for this parameter is marked as an aggregable value, for example, by setting a flag. For example, if the current CPS is set 167 and the current parameter is the parameter FEATURE_APPS (entry 235), then because aggregable field 244 defines the value to be aggregable, the value “S.exe” is marked as being aggregable.

Method 170 may include additional acts not illustrated as part of FIGS. 5A and 5B. For example, after retrieving a value defined for a current parameter in either Act 182 or Act 183, it may be determined whether the retrieved value is defines as having mobility (i.e., being mobile) by the current CPS. Such a determination may be made by accessing mobility field 118 of the appropriate entry 108 of table 106. Alternatively, such determination may be made by accessing one of the other fields 246 of the appropriate entry 231 of table 230.

The value of the mobility field, mobile or non-mobile, dictates whether a value defined for parameter may be assigned to the value for an entity profile being generated for a mobile entity, e.g., a user. A mobile entity is an entity that is capable of being associated with (e.g., capable of logging into a communications network from) more than one network device (more specifically, more than one network address) of the communications network. A user may be considered mobile because a user may be capable of logging in to a communications network from a plurality of network devices. A stationary entity is an entity associated with only one network device of the network device. For example, a network device is a stationary entity.

If it determined that the retrieved value is mobile, then method 170 may proceed onto Act 184 or Act 188, respectively, as described above.

Alternatively, if it determined that the retrieved value is not mobile, then it may be determined whether the value is being defined for a stationary entity, for example, a network device, or for a mobile entity, for example, a user.

If it determined that the value is being defined for a stationary entity, then method 170 may proceed onto Act 184 or Act 188, respectively, as described above.

If it determined that the value is being defined for a mobile entity, then it may be determined if the mobile entity is currently using a network device assigned to the mobile entity or another network device of the communications network not assigned to the mobile entity. It may be the case that the mobile entity is not assigned to any network device, in which case, because the value is defined as non-mobile, the value may not be assigned to the current parameter, and method 170 may proceed to Act 174.

Further, if it determined that the mobile entity is not using a network device assigned to the entity, then the retrieved value may not be assigned to the current parameter, and method 170 may proceed to Act 174.

For example, some applications should be able to configure any network device that a user is using, and thus should be defined as mobile. However there are types of configuration parameters that the user would not want to be mobile. For example, volume or screen contrast typically are specific to a combination of a device, user and/or environment. A user would most likely use a different volume setting for a first type of device in a noisy lab than they would for the same type of device in a quieter office. Similarly, contrast may be highly dependent upon the lighting of the environment the device resides in and the specific user's preferences. These configuration parameters should be defined as non-mobile for a CPS corresponding to a user or user group, so that if is user is logging on to a network device not assigned to the user, the value defined for this configuration parameter cannot be assigned to the parameter as part of generating an entity profile for the user.

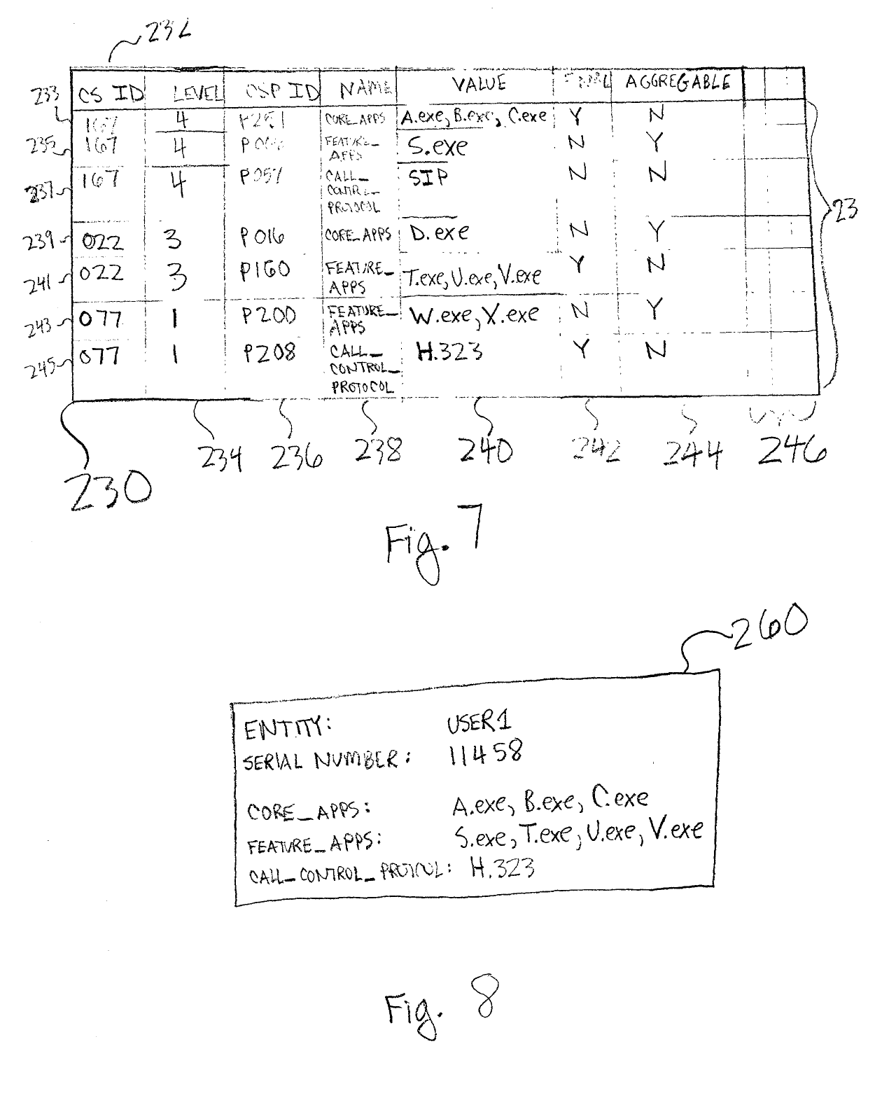

The entity profile illustrated by the text file 260 of FIG. 8 may be generated by applying method 170 to Table 230 as follows. First, in Act 172, CPS 167 of Table 230 may be accessed. Next, by application of Acts 174-196 to entries 233-237, the parameter CORE_APPS may be assigned a value “A.exe, B.exe, C.exe” and marked as final, the parameter FEATURE_APPS may be assigned a value “S.exe” and marked as aggregable, and the parameter named CALL_CONTROL_PROTOCOL may be assigned a value of “SIP.” Next, in Act 172, CPS 022 may be accessed from Table 230. Next, in Act 174 it may be determined by accessing entry 239 that CPS 022 defines the value “D.exe” for the parameter “CORE_APPS.” In following Acts 178 and 180, it may be determined that the value “A.exe, B.exe, C.exe” has already been assigned to the parameter CORE_APPS and that this value has been marked as final. Accordingly, the value of the parameter CORE_APPS remains equal to “A.exe, B.exe, C.exe.” Accordingly, in the next Act 174, it may be determined by accessing entry 241 that CPS 022 defines the value “T.exe, U.exe, V.exe” for the parameter FEATURE_APPS. By applying Acts 178 and 180, it may be determined that the parameter FEATURE_APPS had a previously assigned value, but that this previously assigned value was not a final value for this parameter.

Next, in Act 182, the value “T.exe, U.exe, V.exe” may be retrieved from field 240. In a following Act 184, it may be determined that the previous value assigned to this parameter, “S.exe,” was marked as aggregable. Accordingly, in Act 186, the value “T.exe, U.exe, V.exe” may be aggregated to the value “S.exe” to produce the value “S.exe, T.exe, U.exe, V.exe” for the parameter FEATURE_APPS.

Next, by applying Acts 190 and 196, the new assigned value for FEATURE_APPS may be marked as being final, for example, by setting a flag.

Next, in Act 172, CPS 077 may be accessed from Table 230. By applying Acts 174180, it may be determined by accessing entry 243 that CPS 077 defines the value “W.exe, X.exe” for the parameter FEATURE_APPS, but that the value “S.exe, T.exe, U.exe, V.exe” has already been assigned for this parameter and has been marked as final. Accordingly, the value of parameter FEATURE_APPS remains set equal to “S.exe, T.exe, U.exe, V.exe.” Next, by applying Acts 174, 178, 180, 182, 184 and 188, including accessing entry 245, the previous value of “SIP” for parameter CALL_CONTROL_PROTOCOL, defined by CPS 167, may be overridden and replaced by the value “H.323” defined by CPS 077.

As a result, as illustrated by text file 260 of FIG. 8, the resulting entity profile may include the following parameters have the following values: CORE_APPS=“A.exe, B.exe, C.exe;” FEATURE_APPS=“S.exe, T.exe, U.exe, V.exe;” and CALL_CONTROL_PROTOCOL=“H.323.”

An abstraction of this entity profile may be stored on a volatile recording medium in local memory. Such a memory representation may be implemented according to the type of the application (e.g., a software application written in C, C++ or Java) performing method 140.

Method 140 is merely an illustrative embodiment of a method of combining a plurality of CPSs in accordance with a combining procedure to produce an entity profile. Such an illustrative embodiment is not meant to limit the scope of any of the claims set forth below and is provided merely for illustrative purposes, as any of a variety of other methods of combining a plurality of CPSs in accordance with a combining procedure to produce an entity profile, for example, variations of method 170, may fall within the scope of one or more of the claims set froth below.

Returning to FIG. 4, after the performance of Act 150, next, in Act 152, the entity profile may be persisted. As used herein, the term “persist” and derivations thereof mean to store on a non-volatile recording medium. The entity profile may be persisted using any of a variety of techniques.

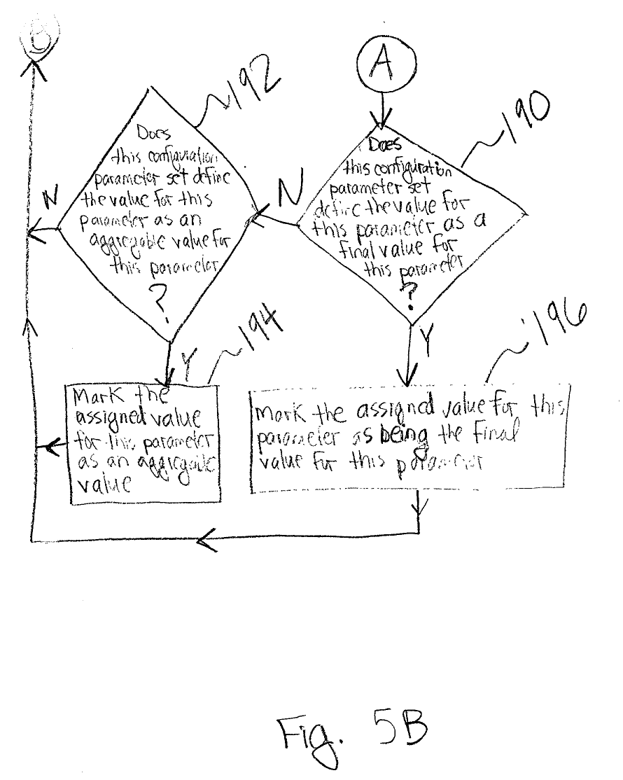

FIG. 6 is a flow chart illustrating an example of a method 210 for persisting the entity profile.

In Act 212, the location at which to persist an abstraction of the entity profile may be determined. For example, such a location may be specified as a uniform resource locator (URL) or another type of location indicator. Such a URL may be determined from a plurality of attributes uniquely identifying a network device. For example, the URL may be a combination of a domain name and possibly a path that specify a network device or a particular directory on the network device.

In a next Act 214, a rendering procedure to apply to the abstraction of the entity profile to produce an abstraction of the entity profile to be persisted may be determined. The rendering procedure to be applied may depend on the data format in which the entity profile is to be persisted. For example, the entity profile may be persisted in a text file as text, where the text may be a plurality of name/value pairs representing the configuration parameters and values determined by method 170, or may be persisted as an extensible markup language (XML) document or an object (e.g., a Java Bean) of an object-oriented database, or as any of a variety of other data structures.

In a following Act 216, the rendering procedure may be applied to the entity profile to produce the abstraction to be persisted, and in Act 218, the produced abstraction may be persisted at the location determined in Act 212. For example, in Act 216, applying the rendering procedure may produce text file 260 of FIG. 8 which may be stored at the location determined in Act 212.

In a next Act 220, a serial number or other version indicator of the entity profile may be updated. For example, the serial number of the entity profile before method 140 was performed may have been an integer, and Act 220 may include adding 1 to the integer.

In a following Act 222, the serial number may be stored in a data structure that also includes an identification of the persisted abstraction of the entity profile and the location of the persisted abstraction. For example, a relational database that includes a plurality of entries, each entry corresponding to an entity, may be provided. Each entry may include a field storing a unique identifier of the entity, a field storing an identification of the persisted abstraction of the entity profile, a field storing the location of the persisted abstraction, and a field storing the serial number of the persisted abstraction. Other data structures may be used to store the serial number, location and identification of the persisted representation.

The order of the acts performed as part of method 210 is not limited to the order illustrated in FIG. 6, as the acts may be performed in other orders. For example, Acts 214 may be performed before Act 212. Further, one or more of the acts of method 210 may be performed in series or in parallel to one or more other acts. For example, at least parts of Acts 212 and 214 may be performed in parallel.

Method 210 is merely an illustrative embodiment of a method of persisting an entity profile. Such an illustrative embodiment is not meant to limit the scope of any of the claims set forth below and is provided merely for illustrative purposes, as any of a variety of other methods of persisting an entity profile, for example, variations of method 210, may fall within the scope of one or more of the claims set froth below.

The order of the acts performed as part of method 140 is not limited to the order illustrated in FIG. 4, as the acts may be performed in other orders. For example, Acts 148 may be performed before Act 146. Further, one or more of the acts of method 140 may be performed in series or in parallel to one or more other acts. For example, at least parts of Acts 146 and 148 may be performed in parallel.

Method 140 is merely an illustrative embodiment of a method of generating an entity profile from a plurality of sets of configuration parameters. Such an illustrative embodiment is not meant to limit the scope of any of the claims set forth below and is provided merely for illustrative purposes, as any of a variety of other methods of generating an entity profile from a plurality of sets of configuration parameters, for example, variations of method 140, may fall within the scope of one or more of the claims set froth below.

Methods 140, 170 and 210 are described above for generating an entity profile from a plurality of CPSs corresponding to entities and entity groups of a same hierarchy. However, two or more CPSs corresponding to entities or entity groups of different hierarchies may be combined to produce an entity profile.

For example, an employee from a sales department may sit down at a TCD in the engineering department and successfully login to a communications network. A plurality of CPSs associated with an administrative hierarchy to which the employee belongs, which includes a CPS corresponding to the sales department, but not the engineering department, may be combined to produce an entity profile for the employee. Further, a plurality of CPSs associated with a device hierarchy to which the TCD of the engineering department belongs may be combined to produce an entity profile for the TCD. A similar example may involve an employee of a first enterprise logging onto a personal computer of another enterprise. A plurality of CPSs associated with an administrative hierarchy to which the first enterprise, but not the second enterprise, belongs may be combined to produce an entity profile for the employee. Further, a plurality of CPSs associated with a device hierarchy to which the personal computer of the second enterprise belongs may be combined to produce an entity profile for the personal computer.

In either case, the employee entity profile and the device (TCD or personal computer) entity profile may be combined to produce a resulting entity profile. Combining may include merely aggregating parameter/value pairs from the two entity profiles, or may include providing values from one entity profile with precedence over values of another entity profile. Such precedence may be implemented in any of a variety of ways. For example, a value defined for a configuration parameter by a device entity profile may have precedence over a value defined for a parameter by an employee entity profile or vice versa.

After the entity profiles have been combined, the resulting entity profile then may be used to configure the network device being used. Alternatively, the entity profiles may not be combined, but both may be used to configure the network device being used. In such a case, the network device may be programmed such that the first value defined for a parameter cannot be overridden, or such that the last value configured for the value has precedence. Other techniques for determining which value has precedence may be used.

Any of a variety of systems may be used to generate an entity profile from a plurality of CPSs. FIG. 9 is an example of a system 280 for combining a plurality of CPSs to produce an entity profile.

The system 280 may include a configuration management module 284 and a database management system (DBMS) 306. The configuration management module 284 may include a configuration control component 286, a combining component 290 and a rendering component 294.

The configuration control component 286 may receive entity info 282 and access DBMS 306 using an entity ID 296 to retrieve persisted entity info 298. The received entity info 282 may include a variety of information about an entity. For example, as described above in relation to Act 142 of method 140, the entity information may include an identification of the entity, such as a unique identifier, as well as a version indicator (e.g., serial number) indicating a version of an entity profile associated with the entity.

The entity information 282 may be received from a first network device, and the configuration management module 284 may reside on a second network device. Alternatively, the entity info 282 may be received from another module of a network device on which the configuration management module 284 resides. In either scenario, the entity info 282 may be received to determine whether the entity information is the most current entity information. Specifically, the entity information 282 may be received to determine if the version of the entity profile included in the entity information 282 is a most recent version of the entity info.

In response to receiving the entity info 282, the configuration control component 286 may retrieve persisted entity information 298 from DBMS 306. For example, the configuration control component 286 may access data stored in DBMS 306 as identified by an entity ID 296 received as part of the entity information 282. The persisted entity information 298 may be part of the configuration data 308 stored within the DBMS. The configuration data 308 may include a plurality of different data stored in a plurality of different formats. For example, the configuration data may include entity profiles stored in any of a variety of formats such as an XML document, a serialized data object, or other data format.

Further, configuration data 308 may include one or more of the tables 62, 72, 82, 92 and 106 described above in relation to FIG. 3 and may include other relational database tables, such as a table including a plurality of entries, where each entry corresponds to an entity or an entity group, wherein one of these entries may correspond to the network entry identified by the entity ID 296.

The configuration control component 286 then may compare the persisted entity info 298 with the received entity info 282. For example, the configuration control component 286 may compare the version indicator (e.g., serial number) of an entity profile included with the persisted entity info 298 to the version indicator included within the entity information 282. If the versions are the same, then the configuration control component may send an indication to the other module or network device that sent the entity information 282 indicating that the other module or network device has the most recent version of the entity profile.

Alternatively, if the versions are not the same, then configuration control component 286 may be configured to send a create entity profile instruction 288 to the combining component 290.

The combining component 290, in response to receiving instruction 288, may use entity ID 296 to extract one or more CPSs 302 from DBMS 306. For example, the combining component 290 may be configured to perform Acts 146-150 as described above in relation to FIG. 4 and FIGS. 5a-5b. The combining component 290 then may combine the one or more CPSs 302 to produce the entity profile data 292, for example, as described above in relation to FIG. 4 and FIGS. 5a-5b.

The rendering component 294 may receive the entity profile data 292, for example, a memory representation of the entity profile 292 described above in relation to FIG. 6, and generate a persisted abstraction of the entity profile 304, for example as described above in relation to FIG. 6.

The rendering component 294 may be configured to store the persisted representation of the entity profile 304 to the DBMS 306, for example, as part of the configuration data 308, and may be configured to send the persisted abstraction of the entity profile 304 to other destinations, for example, a user interface or another network resource of the communications network on which the configuration management module 284 resides.

Further, in addition to or as an alternative to storing the abstraction of the entity profile in DBMS 306, the rendering component 294 may be configured to store the abstraction of the entity profile 304 as one or more files on one or more network devices as part of a file system. For example, a copy of the entity profile may be stored on the network device on which configuration management module 284 resides and other copies of the entity profile may be stored on other network devices of the network. These copies may be accessible by a web server, for example, an HTTP server.

Storing one or more files of the abstraction of the entity profile on one or more network devices, in addition to storing the abstraction in the DBMS 306, provides redundancy protection in case the DBMS 306 fails or becomes unavailable to one or more network devices. Further, these additional copies of the entity profile may provide faster access to the entity profile, for example, by a web browser, than does the DBMS 306, and may provide load balancing for the communications network.

The configuration management module 284 may be implemented using any of a variety of software, firmware, hardware, or any combination thereof. For example, the configuration management module 284 may be implemented using Enterprise Java Beans (EJBs) as part of Javasoft from Sun Microsystems of Palo Alto, Ca, available at: http://wwwjavasoft.com/products/ejb/index.html, where an EJB session may be used to implement components 286, 290 and 294 and generate an entity profile from a plurality of CPSs. The DBMS 306 may be implemented using any of a variety of database management software, for example, PostgreSQL, available from PostgreSQL Inc. of Wolfville, Nova Scotia, Canada.

For transactions between the DBMS 306 and the configuration management module 284, Java database connectivity (JDBC) may be used, for example, JDBC developed using an API defined for Javasoft by Sun Microsystems may be used. The JDBC may be implemented by the database vendor (e.g., Oracle Corporation). Accordingly, the configuration management module 284 may create a separate EJB entity for each entry extracted from one of these database tables.

To communicate with other network devices external to the network device on which the configuration management module resides, the configuration management module may include a web container including one or more Java servlets and/or Java server pages (JSPs), where each JSP or Java servlet corresponds to a remote network device. The web container may transact with the EJB session described above using any of a variety of techniques, for example, using Remote Method Innovation (RMI), Internet Inter-Orb Protocol (IIOP), or a combination thereof. RMI is a capability and API provided as part of the Java language, for example, provided as part of Javasoft from Sun Microsystems of Palo Alto, Calif. IIOP is a standard technique for communicating with Common Object Request Broker Architecture (CORBA) objects. CORBA is a technology for defining object-oriented interfaces to remote objects that provide functionality on a different machine (i.e., network device) or process. Accordingly, RMI and IIOP are technologies for providing remote communications between two or more processes on a same or different network device. For more details regarding RMI and IIOP, see: http://www.javasoft.com/products/rmi-iiop/index.html.

The configuration management module 284 also may include a presentation layer (not shown) to communicate between the web container and the one or more other remote network devices transacting with the configuration management module 284.

Further, the configuration management module may reside on any of a variety of network devices of a communications network, for example, a TCD, companion device TCD deployment server, or combination thereof of a telephony communications network.

System 280, and components thereof such as components 284, 286, 290, 294 and 306, may be implemented as software (e.g., C, C++, Java, or a combination thereof), hardware (e.g., one or more application-specific integrated circuits), firmware (e.g., electrically-programmed memory) or any combination thereof. System 280 and components thereof may reside on a single machine, for example, a TCD or deployment server of a telephony communications network as described above in relation to FIG. 1, or may be modular and reside on multiple interconnected machines. For example, all of the components 284, 286, 290, 294 and 306 may reside on a TCD or a deployment server, or any combination of these components and sub-components thereof may be distributed between one or more TCDs and one or more deployment servers.

Further, on each of the one or more machines that include the system 280 or components thereof, the system 280 and/or components may reside in one or more locations on the machines. For example, different portions of the system 280 and/or components 284, 286, 290, 294 and 306 may reside in different areas of memory (e.g., RAM, ROM, disk, etc.) on a computer. Each of such one or more machines may include, among other components, a plurality of known components such as one or more processors, a memory system, a disk storage system, one or more network interfaces, and one or more busses or other internal communication links interconnecting the various components.

System 280 is merely an illustrative embodiment of a system for generating an entity profile from a plurality of sets of configuration parameters. Such an illustrative embodiment is not meant to limit the scope of any of the claims set forth below and is provided merely for illustrative purposes, as any of a variety of other systems for generating an entity profile from a plurality of sets of configuration parameters, for example, variations of system 280, may fall within the scope of one or more of the claims set forth below.

Methods 140, 170 and 210, described above in relation to FIGS. 4-6, and acts thereof, including Acts 142-152, Acts 172-196 and Acts 212-222, respectively, and various embodiments and variations of these methods and acts, individually or in combination may be implemented as a computer program product tangibly embodied as computer-readable signals on a computer-readable medium, for example, a non-volatile recording medium, an integrated circuit memory element, or a combination thereof. Such a computer program product may comprise computer-readable signals tangibly embodied on the computer-readable medium, where such signals define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, C or C++, or any of a variety of combinations thereof.

Having now described some illustrative embodiments of the invention claimed below, it should be apparent to those skilled in the art that the foregoing is merely illustrative and not limiting, having been presented by way of example only. Numerous modification and other illustrative embodiments are within the scope of one of ordinary skill in the art and are contemplated as falling within the scope of the claims set forth below. In particular, although many of the examples presented herein involve specific combinations of method acts or system elements, it should be understood that those acts and those elements may be combined in other ways to accomplish the same objectives. Acts, elements and features discussed only in connection with one embodiment of a system or method are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

What is claimed is:

1. A method of assigning values to one or more configuration parameters of a first entity associated with a communications network, wherein the entity is a member of a hierarchy of entity groups, the communications network comprising a computer-readable medium, the method comprising acts of:
(a) retrieving from the computer-readable medium a plurality of sets of configuration parameters for configuring a network device of the communications network, wherein each set corresponds to either the entity or one of the entity groups, and wherein for each set, for one or more configuration parameters, the set defines a value for the configuration parameter; and
(b) combining the plurality of sets of configuration parameters to produce an entity profile for the first entity, wherein the entity profile comprises one or more configuration parameters and comprises, for each parameter, a corresponding value assigned from one of the plurality of sets of configuration parameters.

2. The method of claim 1, further comprising an act of:
(c) configuring the network device of the communications network using the entity profile.

3. The method of claim 1, wherein the act of combining comprises:
for each of the one or more configuration parameters, assigning a value from one of the plurality of configuration sets to the configuration parameter.

4. The method of claim 1, wherein the hierarchy is an administrative hierarchy, and each entity group is a group of administrative entities.

5. The method of claim 1, wherein the hierarchy is a network device hierarchy, and each entity group is a group of network devices.

6. The method of claim 1, wherein the hierarchy is a network user hierarchy, and each entity group is a group of network users.

7. The method of claim 1, wherein a first combining procedure is accessible on the communications network, the first combining procedure defining a procedure by which to combine the plurality of sets of configuration parameters, and wherein act (b) further comprises:
combining the plurality of sets of configuration parameters in accordance with the combining procedure.

8. The method of claim 7, wherein a plurality of combining procedures, comprising the first combining procedure, are available on the communications network, and the method further comprises an act of:
(c) selecting the first combining procedure from the plurality of combining procedures.

9. The method of claim 7, wherein the first combining procedure specifies one or more of the entity groups for which corresponding sets of configuration parameters are not to be combined, and wherein act (b) further comprises:
refraining from combining one or more sets of configuration parameters, each of the one or more sets corresponding to one of the entity groups specified by the first combining procedure.

10. The method of claim 7, wherein a first of the plurality of sets of configuration parameters corresponds to a highest entity group of the hierarchy, and wherein act (b) comprises:
combining the plurality of sets of configuration parameters in accordance with the hierarchy, starting with the first set of configuration parameters.

11. The method of claim 1, wherein a first of the plurality of sets of configuration parameters defines a first value for a first configuration parameter and defines the first value as being a final value for the first configuration parameter, and a second of the plurality of sets of configuration parameters defines a second value for the first configuration parameter, wherein act (b) comprises:
accessing the first set of configuration parameters;
assigning the first value to the first configuration parameter and marking the first value as a final value for the first configuration parameter;
accessing the second set of configuration parameters; and
refraining from assigning the second value to the first configuration parameter in response to the first value being marked as the final value for the first configuration parameter.

12. The method of claim 1, wherein a first of the plurality of sets of configuration parameters defines a first value for a first configuration parameter and defines the first value as being aggregable, and a second of the plurality of sets of configuration parameters defines a second value for the first configuration parameter, wherein act (b) comprises:
accessing the first set of configuration parameters;
assigning the first value to the first configuration parameter and marking the first value as aggregable;
accessing the second set of configuration parameters; and
in response to the first value being marked as aggregable, aggregating the second value to the first value to produce an aggregated value and assigning the aggregated value to the first configuration parameter.

13. The method of claim 1, wherein a first of the plurality of sets of configuration parameters defines a first value for a first configuration parameter, and a second of the plurality of sets of configuration parameters defines a second value for the first configuration parameter, wherein act (b) comprises:
accessing the first set of configuration parameters;
assigning the first value to the first configuration parameter;
accessing the second set of configuration parameters; and
overriding the first value by assigning the second value to the first configuration parameter.

14. The method of claim 1, wherein the entity is a telephony communications device that is part of the communications network.

15. The method of claim 1, wherein the entity is a user of a network device that is part of the communications network.

16. The method of claim 1, wherein the plurality of sets of configuration parameters are stored in a relational database on the computer-readable medium, and act (a) comprises:
accessing the relational database to retrieve the plurality of sets of configuration parameters.

17. A system for assigning values to one or more configuration parameters of a first entity associated with a communications network wherein the entity is a member of a hierarchy of entity groups, the communications network comprising a computer-readable medium, the system comprising:
a configuration management module comprising one or more inputs to receive from the computer-readable medium a plurality of sets of configuration parameters for configuring a network device of the communications network, wherein each set corresponds to either the entity or one of the entity groups, and wherein for each set, for one or more configuration parameters, the set defines a value for the configuration parameter, logic to combine the plurality of sets of configuration parameters to produce an entity profile for the first entity, wherein the entity profile comprises one or more configuration parameters and comprises, for each parameter, a corresponding value assigned from one of the plurality of sets of configuration parameters, and an output to output the entity profile.

18. The system of claim 17, wherein the logic of the configuration management module is further operative to configure the network device of the communications network using the entity profile.

19. The system of claim 17, wherein the logic of the configuration management module is further operative, for each of the one or more configuration parameters, to assign a value from one of the plurality of configuration sets to the configuration parameter.

20. The system of claim 17, wherein the hierarchy is an administrative hierarchy, and each entity group is a group of administrative entities.

21. The system of claim 17, wherein the hierarchy is a network device hierarchy, and each entity group is a group of network devices.

22. The system of claim 17, wherein the hierarchy is a network user hierarchy, and each entity group is a group of network users.

23. The system of claim 17, wherein a first combining procedure is accessible on the communications network, the first combining procedure defining a procedure by which to combine the plurality of sets of configuration parameters, and wherein the logic of the configuration management module is further operative to combine the plurality of sets of configuration parameters in accordance with the combining procedure.

24. The system of claim 23, wherein a plurality of combining procedures, comprising the first combining procedure, are available on the communications network, and the logic of the configuration management module is further operative to select the first combining procedure from the plurality of combining procedures.

25. The system of claim 23, wherein the first combining procedure specifies one or more of the entity groups for which corresponding sets of configuration parameters are not to be combined, wherein the logic of the configuration management module is further operative to refrain from combining one or more sets of configuration parameters, each of the one or more sets corresponding to one of the entity groups specified by the first combining procedure.

26. The system of claim 23, wherein a first of the plurality of sets of configuration parameters corresponds to a highest entity group of the hierarchy, and wherein the logic of the configuration management module is further operative to combine the plurality of sets of configuration parameters in accordance with the hierarchy, starting with the first set of configuration parameters.

27. The system of claim 17, wherein a first of the plurality of sets of configuration parameters defines a first value for a first configuration parameter and defines the first value as being a final value for the first configuration parameter, and a second of the plurality of sets of configuration parameters defines a second value for the first configuration parameter,
wherein the logic of the configuration management module is further operative to access the first set of configuration parameters, to assign the first value to the first configuration parameter and mark the first value as a final value for the first configuration parameter, to access the second set of configuration parameters, and to refrain from assigning the second value to the first configuration parameter in response to the first value being marked as the final value for the first configuration parameter.

28. The system of claim 17, wherein a first of the plurality of sets of configuration parameters defines a first value for a first configuration parameter and defines the first value as being aggregable, and a second of the plurality of sets of configuration parameters defines a second value for the first configuration parameter,
wherein the logic of the configuration management module is further operative to access the first set of configuration parameters, to assign the first value to the first configuration parameter and mark the first value as aggregable, to access the second set of configuration parameters, and, to aggregate, in response to the first value being marked as aggregable, the second value to the first value to produce an aggregated value and to assign the aggregated value to the first configuration parameter.

29. The system of claim 17, wherein a first of the plurality of sets of configuration parameters defines a first value for a first configuration parameter, and a second of the plurality of sets of configuration parameters defines a second value for the first configuration parameter,
wherein the logic of the configuration management module is further operative to access the first set of configuration parameters, to assign the first value to the first configuration parameter, to access the second set of configuration parameters, and to override the first value by assigning the second value to the first configuration parameter.

30. The system of claim 17, wherein the entity is a telephony communications device that is part of the communications network.

31. The system of claim 17, wherein the entity is a user of a network device that is part of the communications network.

32. The system of claim 17, wherein the plurality of sets of configuration parameters are stored in a relational database on the computer-readable medium, and wherein the logic of the configuration management module is further operative to access the relational database to retrieve the plurality of sets of configuration parameters.

33. A system for assigning values to one or more configuration parameters of a first entity associated with a communications network wherein the entity is a member of a hierarchy of entity groups, the communications network comprising a computer-readable medium, the system comprising:
means for retrieving from the computer-readable medium a plurality of sets of configuration parameters for configuring a network device of the communications network, wherein each set corresponds to either the entity or one of the entity groups, and wherein for each set, for one or more configuration parameters, the set defines a value for the configuration parameter; and
means for combining the plurality of sets of configuration parameters to produce an entity profile for the first entity, wherein the entity profile comprises one or more configuration parameters and comprises, for each parameter, a corresponding value assigned from one of the plurality of sets of configuration parameters.

34. The system of claim 33, further comprising:
means for configuring the network device of the communications network using the entity profile.

35. The system of claim 33, wherein the means for combining comprises:
means for assigning, for each of the one or more configuration parameters, a value from one of the plurality of configuration sets to the configuration parameter.

36. The system of claim 33, wherein the hierarchy is an administrative hierarchy, and each entity group is a group of administrative entities.

37. The system of claim 33, wherein the hierarchy is a network device hierarchy, and each entity group is a group of network devices.

38. The system of claim 33, wherein the hierarchy is a network user hierarchy, and each entity group is group of network users.

39. The system of claim 33, wherein a first combining procedure is accessible on the communications network, the first combining procedure defining a procedure by which to combine the plurality of sets of configuration parameters, and wherein the means for combining further comprises:
means for combining the plurality of sets of configuration parameters in accordance with the combining procedure.

40. The system of claim 39, wherein a plurality of combining procedures, comprising the first combining procedure, are available on the communications network, and the system further comprises:
means for selecting the first combining procedure from the plurality of combining procedures.

41. The system of claim 39, wherein the first combining procedure specifies one or more of the entity groups for which corresponding sets of configuration parameters are not to be combined, and the means for combining further comprises:
means for refraining from combining one or more sets of configuration parameters, each of the one or more sets corresponding to one of the entity groups specified by the first combining procedure.

42. The system of claim 39, wherein a first of the plurality of sets of configuration parameters corresponds to a highest entity group of the hierarchy, and wherein the means for combining comprises:
means for combining the plurality of sets of configuration parameters in accordance with the hierarchy, starting with the first set of configuration parameters.

43. The system of claim 33, wherein a first of the plurality of sets of configuration parameters defines a first value for a first configuration parameter and defines the first value as being a final value for the first configuration parameter, and a second of the plurality of sets of configuration parameters defines a second value for the first configuration parameter, wherein the means for combining comprises:
means for accessing the first set of configuration parameters;
means for assigning the first value to the first configuration parameter and marking the first value as a final value for the first configuration parameter;
means for accessing the second set of configuration parameters; and
means for refraining from assigning the second value to the first configuration parameter in response to the first value being marked as the final value for the first configuration parameter.

44. The system of claim 33, wherein a first of the plurality of sets of configuration parameters defines a first value for a first configuration parameter and defines the first value as being aggregable, and a second of the plurality of sets of configuration parameters defines a second value for the first configuration parameter, wherein act (b) comprises:
means for accessing the first set of configuration parameters;
means for assigning the first value to the first configuration parameter and marking the first value as aggregable;
means for accessing the second set of configuration parameters; and
means for aggregating, in response to the first value being marked as aggregable, the second value to the first value to produce an aggregated value and assigning the aggregated value to the first configuration parameter.

45. The system of claim 33, wherein a first of the plurality of sets of configuration parameters defines a first value for a first configuration parameter, and a second of the plurality of sets of configuration parameters defines a second value for the first configuration parameter, wherein the means for combining further comprises:
means for accessing the first set of configuration parameters;
means for assigning the first value to the first configuration parameter;
means for accessing the second set of configuration parameters; and
means for overriding the first value by assigning the second value to the first configuration parameter.

46. The system of claim 33, wherein the entity is a telephony communications device that is part of the communications network.

47. The system of claim 33, wherein the entity is a user of a network device that is part of the communications network.

48. The system of claim 33, wherein the plurality of sets of configuration parameters are stored in a relational database on the computer-readable medium, and the means for retrieving comprises:
means for accessing the relational database to retrieve the plurality of sets of configuration parameters.

49. A computer program product, comprising:
a computer-readable medium; and
computer-readable signals stored on the computer-readable medium that define instructions that, as a result of being executed by a computer, instruct the computer to perform a process of assigning values to one or more configuration parameters of a first entity associated with a communications network wherein the entity is a member of a hierarchy of entity groups, the communications network comprising a computer-readable medium, the process comprising acts of:
(a) retrieving from the computer-readable medium a plurality of sets of configuration parameters for configuring a network device of the communications network, wherein each set corresponds to either the entity or one of the entity groups, and wherein for each set, for one or more configuration parameters, the set defines a value for the configuration parameter; and
(b) combining the plurality of sets of configuration parameters to produce an entity profile for the first entity, wherein the entity profile comprises one or more configuration parameters and comprises, for each parameter, a corresponding value assigned from one of the plurality of sets of configuration parameters.

50. The computer program product of claim 49, wherein the process further comprises an act of:
(c) configuring the network device of the communications network using the entity profile.

51. The computer program product of claim 49, wherein the act of combining comprises:
for each of the one or more configuration parameters, assigning a value from one of the plurality of configuration sets to the configuration parameter.

52. The computer program product of claim 49, wherein the hierarchy is an administrative hierarchy, and each entity group is a group of administrative entities.

53. The computer program product of claim 49, wherein the hierarchy is a network device hierarchy, and each entity group is a group of network devices.

54. The computer program product of claim 49, wherein the hierarchy is a network user hierarchy, and each entity group is a group of network users.

55. The computer program product of claim 49, wherein a first combining procedure is accessible on the communications network, the first combining procedure defining a procedure by which to combine the plurality of sets of configuration parameters, and wherein act (b) further comprises:
combining the plurality of sets of configuration parameters in accordance with the combining procedure.

56. The computer program product of claim 55, wherein a plurality of combining procedures, comprising the first combining procedure, are available on the communications network, and the process further comprises an act of:
(c) selecting the first combining procedure from the plurality of combining procedures.

57. The computer program product of claim 55, wherein the first combining procedure specifies one or more of the entity groups for which corresponding sets of configuration parameters are not to be combined as part of act (b), wherein act (b) further comprises:
refraining from combining one or more sets of configuration parameters, each of the one or more sets corresponding to one of the entity groups specified by the first combining procedure.

58. The computer program product of claim 55, wherein a first of the plurality of sets of configuration parameters corresponds to a highest entity group of the hierarchy, and wherein act (b) comprises:
combining the plurality of sets of configuration parameters in accordance with the hierarchy, starting with the first set of configuration parameters.

59. The computer program product of claim 49, wherein a first of the plurality of sets of configuration parameters defines a first value for a first configuration parameter and defines the first value as being a final value for the first configuration parameter, and a second of the plurality of sets of configuration parameters defines a second value for the first configuration parameter, wherein act (b) comprises:
accessing the first set of configuration parameters;
assigning the first value to the first configuration parameter and marking the first value as a final value for the first configuration parameter;
accessing the second set of configuration parameters; and
refraining from assigning the second value to the first configuration parameter in response to the first value being marked as the final value for the first configuration parameter.

60. The computer program product of claim 49, wherein a first of the plurality of sets of configuration parameters defines a first value for a first configuration parameter and defines the first value as being aggregable, and a second of the plurality of sets of configuration parameters defines a second value for the first configuration parameter, wherein act (b) comprises:
accessing the first set of configuration parameters;
assigning the first value to the first configuration parameter and marking the first value as aggregable;
accessing the second set of configuration parameters; and
in response to the first value being marked as aggregable, aggregating the second value to the first value to produce an aggregated value and assigning the aggregated value to the first configuration parameter.

61. The computer program product of claim 49, wherein a first of the plurality of sets of configuration parameters defines a first value for a first configuration parameter, and a second of the plurality of sets of configuration parameters defines a second value for the first configuration parameter, wherein act (b) comprises:
accessing the first set of configuration parameters;
assigning the first value to the first configuration parameter;
accessing the second set of configuration parameters; and
overriding the first value by assigning the second value to the first configuration parameter.

62. The computer program product of claim 49, wherein the entity is a telephony communications device that is part of the communications network.

63. The computer program product of claim 49, wherein the entity is a user of a network device that is part of the communications network.

64. The computer program product of claim 49, wherein the plurality of sets of configuration parameters are stored in a relational database on the computer-readable medium, and act (a) comprises:
accessing the relational database to retrieve the plurality of sets of configuration parameters.

65. A digital information product, comprising:
a computer-readable medium; and
first signals tangibly-embodied on the computer-readable medium, the signals defining, for an entity associated with a communications network and that belongs to one or more entity groups of a hierarchy of entity groups, a plurality of sets of configuration parameters for configuring a network device of the communications network, wherein each set corresponds to either the entity or one of the entity groups and, for each set, for one or more configuration parameters, the set defines a value for the configuration parameter.

66. The digital information product of claim 65, wherein at least two of the plurality of sets of configuration parameters define a value for a same configuration parameter.

67. The digital information product of claim 65, wherein the hierarchy is an administrative hierarchy, and each entity group is a group of administrative entities.

68. The digital information product of claim 65, wherein the hierarchy is a network device hierarchy, and each entity group is a group of network devices.

69. The digital information product of claim 65, wherein the hierarchy is a network user hierarchy, and each entity group is a group of network users.

70. The digital information product of claim 65, wherein a first of the plurality of sets of configuration parameters defines a first value for a first configuration parameter and defines the first value as being a final value for the first configuration parameter such that the first value cannot be overridden by another value defined for the first parameter by another set of configuration parameters.

71. The digital information product of claim 65, wherein a first of the plurality of sets of configuration parameters defines a first value for a first configuration parameter and defines the first value as being aggregable such that the first value can be aggregated with another value defined for the first parameter by another set of configuration parameters.

72. The digital information product of claim 65, wherein a first of the plurality of sets of configuration parameters defines a first value for a first configuration parameter such that the first value can be overridden by another value defined for the first parameter by another set of configuration parameters.

73. The digital information product of claim 65, wherein the entity is a telephony communications device that is part of the communications network.

74. The digital information product of claim 65, wherein the entity is a user of a network device that is part of the communications network.

75. The digital information product of claim 65, wherein the plurality of sets of configuration parameters are stored in a relational database on the computer-readable medium.
